(19) United States
(12) Patent Application Publication
(10) Pub. No.: US 2025/0020839 A1
(43) Pub. Date: Jan. 16, 2025

(54) EFFICIENT MODELING OF A DIFFRACTIVE WAVEGUIDE

(71) Applicant: GOOGLE LLC, Mountain View, CA (US)

(72) Inventor: Qinglan Huang, Mountain View, CA (US)

(21) Appl. No.: 18/221,692

(22) Filed: Jul. 13, 2023

(51) Int. Cl. G02B 5/18; G02B 6/34; G02B 27/00; G02B 27/01; G02B 27/42

(52) U.S. Cl. CPC G02B 5/1819; G02B 6/34; G02B 27/0081; G02B 27/0172; G02B 27/4233; G02B 27/4266; G02B 2027/0118; G02B 2027/014

(57) ABSTRACT

A method of simulating the optical performance of a diffractive waveguide includes, generating a plurality of transfer matrices for each diffractive grating of the plurality of diffractive gratings responsive to performing a diffraction modeling process for a plurality of diffractive gratings of the waveguide based on a plurality of input light rays each having at least a different first characteristic. A plurality of electric fields at outcoupling positions of an outcoupling grating of the plurality of diffractive gratings is determined based on the plurality of transfer matrices responsive to performing a ray tracing process for multiple instances of each input light ray of the plurality of light rays with at least a different second characteristic. A uniformity map is generated for the waveguide based on the plurality of electric fields. The uniformity map indicates a uniformity of one or more characteristics of the waveguide across different sampled pupil positions.

### BACKGROUND

Near-to-eye display (NED) devices (e.g., augmented reality glasses, mixed reality glasses, virtual reality headsets, and the like) are wearable electronic devices that combine real-world and virtual images via one or more optical combiners, such as one or more integrated combiner lenses, to provide a virtual display that is viewable by a user when the wearable display device is worn on the head of the user. One class of optical combiner uses a waveguide (also termed a lightguide) to transfer light. In general, light from a projector of the wearable display device enters the waveguide of the optical combiner through an incoupler, propagates along the waveguide, and exits the waveguide through an outcoupler. If the pupil of the eye is aligned with one or more exit pupils provided by the outcoupler, at least a portion of the light exiting through the outcoupler will enter the pupil of the eye, thereby enabling the user to see a virtual image. Since the combiner lens is transparent, the user will also be able to see the real world.

### SUMMARY OF EMBODIMENTS

In accordance with one aspect, a method includes generating a plurality of transfer matrices for each diffractive grating of the plurality of diffractive gratings and background areas of the waveguide responsive to performing a diffraction modeling process for a plurality of diffractive gratings of a waveguide based on a plurality of input light rays each having at least a different first characteristic A plurality of electric fields at outcoupling positions of an outcoupling grating of the plurality of diffractive gratings is determined based on the plurality of transfer matrices responsive to performing a ray tracing process for multiple instances of each input light ray of the plurality of input light rays with at least a different second characteristic. A uniformity map for the waveguide is generated based on the plurality of electric fields, the uniformity map indicating a uniformity of one or more characteristics of the waveguide across different sampled pupil positions.

In accordance with another aspect, a processing system includes a processor and a waveguide modeler. The waveguide modeler is configured by the processor to generate a plurality of transfer matrices for each diffractive grating of the plurality of diffractive gratings and background areas of the waveguide responsive to a diffraction modeling process performed for a plurality of diffractive gratings of a waveguide based on a plurality of input light rays each having at least a different first characteristic. The waveguide modeler is further configured by the processor to determine a plurality of electric fields at outcoupling positions of an outcoupling grating of the plurality of diffractive gratings based on the plurality of transfer matrices responsive to a ray tracing process performed for multiple instances of each input light ray of the plurality of input light rays with at least a different second characteristic. The waveguide modeler is further configured by the processor to generate a uniformity map for the waveguide based on the plurality of electric fields, the uniformity map indicating a uniformity of one or more characteristics of the waveguide across different sampled pupil positions.

In accordance with a further aspect, a wearable head-mounted display system includes an image source to project light comprising an image, at least one lens element, and waveguide. The waveguide is designed by a process including generating a plurality of transfer matrices for each diffractive grating of the plurality of diffractive gratings and background areas of the waveguide responsive to performing a diffraction modeling process for a plurality of diffractive gratings of a waveguide based on a plurality of input light rays each having at least a different first characteristic. A plurality of electric fields at outcoupling positions of an outcoupling grating of the plurality of diffractive gratings is determined based on the plurality of transfer matrices responsive to performing a ray tracing process for multiple instances of each input light ray of the plurality of input light rays with at least a different second characteristic. A uniformity map for the waveguide is generated based on the plurality of electric fields, the uniformity map indicating a uniformity of one or more characteristics of the waveguide across different sampled pupil positions.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example processing system configured to implement the waveguide modeling techniques described herein in accordance with some embodiments.

FIG. 2 illustrates an example configuration of a waveguide in accordance with some embodiments.

FIG. 3 illustrates a detailed view of a waveguide modeler implemented by the processing system of FIG. 1 in accordance with some embodiments.

FIG. 4 illustrates an example grid of nodes generated for a waveguide that is used during a ray tracing process for calculating the electric fields of the waveguide and grating structures in accordance with some embodiments.

FIG. 5 illustrates an example k-space diagram in accordance with some embodiments.

FIG. 6 illustrates a portion of the grid in FIG. 4 that is in an exit-pupil-expander area of a waveguide and the dependency between the nodes with respect to their electric fields in accordance with some embodiments.

FIG. 7 illustrates an example pupil efficiency uniformity map generated for a waveguide based on the waveguide modeling techniques described herein in accordance with some embodiments.

FIG. 8 illustrates a pupil efficiency uniformity map generated for a waveguide based on the waveguide modeling techniques described herein that shows color non-uniformity of a waveguide in accordance with some embodiments.

FIG. 9 illustrates an example of a pupil efficiency uniformity map for the waveguide of FIG. 8 with improved color uniformity after design parameters of the waveguide were adjusted based on the pupil efficiency uniformity map of FIG. 9 in accordance with some embodiments.

FIG. 10 illustrates a pupil efficiency uniformity map generated for a waveguide based on the waveguide modeling techniques described herein that shows brightness non-uniformity of a waveguide in accordance with some embodiments.

FIG. 11 illustrates an example of a pupil efficiency uniformity map for the waveguide of FIG. 10 with improved brightness uniformity after design parameters of the waveguide were adjusted based on the pupil efficiency uniformity map of FIG. 10 in accordance with some embodiments.

FIG. 12 illustrates an example tree-diagram representation of light bounces within a waveguide and grating structures in accordance with some embodiments.

FIG. 13 illustrates another example tree-diagram representation of light bounces within a waveguide and grating structures in accordance with some embodiments.

FIG. 14 and FIG. 15 together are a flow diagram illustrating an example method for efficiently and accurately simulating the optical performance of a diffractive waveguide in accordance with some implementations.

FIG. 16 illustrates an example display system in accordance with some embodiments.

### DETAILED DESCRIPTION

Prior to being implemented in NEDs and other devices, waveguides need to be designed and fabricated. A waveguide design is typically modeled so that various aspects of the design can be examined to ensure optimal performance of the waveguide. For example, light propagation, modes of propagation, waveguide geometry, material properties, coupling efficiency, and other aspects of the waveguide design are modeled. By modeling these waveguide aspects, designers can predict the waveguide's performance, optimize the design of the waveguide, and assess how changes to the waveguide might impact the NED's overall performance.

However, modeling a waveguide, such as a diffractive waveguide, is a challenging problem since two drastically different optics regimes, i.e., diffractive optics and refractive optics, typically need to be bridged. Most current modeling techniques and tools are configured to either model diffractive optics or refractive optics, but not both. For example, diffractive waveguides typically implement nanometer-scale diffractive gratings and a macroscopic waveguide structure. The nanoscale diffractive gratings are typically modeled using, for example, either Rigorous Coupled-Wave Analysis (RCWA) or Finite-Different Time-Domain (FDTD). In contrast, light ray propagation inside the macroscopic waveguide structure is typically modeled using a computational tool referred to as a “ray tracer”, which models the effects of the waveguide refractive optics as light rays propagate through the waveguide. Current modeling techniques and tools are not able to effectively integrate the two disparate types of modeling so that diffractive waveguides can be efficiently and accurately modeled.

As such, the following describes embodiments of systems and methods for efficiently and accurately simulating the optical performance of a diffractive waveguide by integrating both diffractive grating modeling to model the wave optics effect and ray tracing to model the refractive optics effect. As described in greater detail below, a waveguide modeler simulates a plurality of input light rays, each having a different wavelength or range of wavelengths (e.g., red, green, or blue wavelengths). Each of these input light rays is simulated multiple times, with each simulation projecting the input light ray onto an input coupler (IC) grating of the waveguide at different field-of-view (FOV) angle (also referred to herein as “field angles” or “incident angles”). Each input light ray simulated with a different field angle is evaluated for multiple different incident ray positions on the IC grating of the waveguide to determine the optical performance of the waveguide. As such, in at least some embodiments, a light ray simulation refers to simulating a light ray having a specified wavelength that is projected with a specified field angle onto the IC of the waveguide at a specified incident position.

For example, given a simulated input light ray having a specified wavelength(s) and a specified field angle, the waveguide modeler performs a diffraction modeling process for each grating structure, such as the IC grating, an exit pupil expander (EPE) grating, and an outcoupler (OC) grating, of the waveguide. The diffraction modeling process executes one or more computational techniques, such as RCWA, on each grating structure to generate a transfer matrix for each interaction between the light ray and the grating. Stated differently, the diffraction modeling process generates transfer matrices between the input light rays and the light rays diffracted by the grating structure.

The waveguide modeler then performs ray tracing for the simulated input light ray. For example, the waveguide modeler selects an incident ray position on the waveguide and, based on the selected incident ray position, generates a grid of nodes where the light ray intersects the waveguide and grating surfaces. Each bounce the light ray makes on the waveguide or grating surface is a node in the grid of nodes. In at least some embodiments, the positions of the nodes are determined from a k-space diagram generated for the waveguide. The waveguide modeler recursively calculates the near-field electric field (also referred to herein as “E-field”) of each node in the grid of nodes using transfer matrices generated during the diffraction modeling process. The transfer matrices relate the E-field of one node to its neighboring nodes. As such, the E-field of each node in the grid of nodes is determined by recursively performing matrix multiplication using one or more transfer matrices generated for the grating structures of the waveguide and neighboring E-fields. The output of an iteration of the ray tracing process, in at least some embodiments, is the E-field associated with each node in the OC of the waveguide. Stated differently, the output of an iteration of the ray tracing process is a set of output E-fields comprised of the E-field for each light ray outcoupled by the OC of the waveguide.

The waveguide modeler then simulates the input light ray with a different field angle and performs the diffraction modeling process described above to generate a new set of transfer matrices. The waveguide modeler repeats the ray-tracing process using the new set of transfer matrices to generate the output E-fields for the current simulated input light ray. The diffraction modeling process and ray-tracing process are repeated until the input light ray having the specified wavelength(s) has been simulated with each remaining field angle of interest. The waveguide modeler also performs the diffraction modeling process and ray-tracing process for additional input light rays simulated with different wavelengths or ranges of wavelengths. For example, if the first simulated input light had a red wavelength range, the waveguide modeler repeats the diffraction modeling and ray-tracing processes for a simulated input light ray having a blue wavelength range and a simulated input light ray having a green wavelength range.

Given the output E-fields for all the field angles of the different input light rays, the waveguide modeler generates a pupil efficiency uniformity map (also referred to herein as “far-field uniformity map”). The pupil efficiency uniformity map indicates the efficiency of the waveguide. For example, the pupil efficiency uniformity map indicates, for different sampled pupil positions and field angles, the brightness of the outcoupled light rays, the color and brightness uniformity of the outcoupled light rays, and the like. This information can be used to determine if the overall waveguide or individual components of the waveguide are performing according to design specifications. Also, in at least some embodiments, the pupil efficiency uniformity map is used to adjust the design parameters of the waveguide and its components, such as the grating structures, to increase the performance of the waveguide.

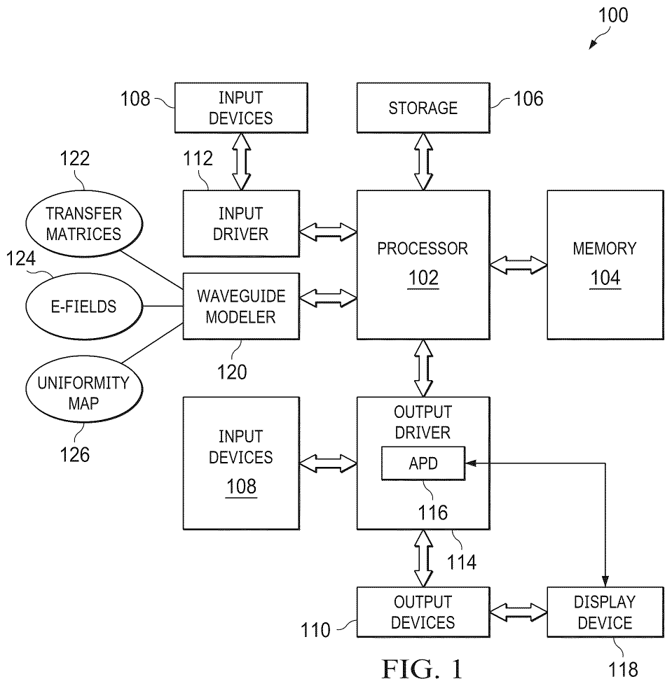

FIG. 1 illustrates a block diagram of an example processing system in which the waveguide modeling techniques described herein can be implemented. It should be understood that the techniques described herein are not limited to the processing system 100 shown in FIG. 1. In at least some embodiments, the processing system 100 includes, for example, a server, a desktop computer, a laptop/notebook, a mobile device, a tablet computing device, a wearable computing device, or the like. The processing system 100, in at least some embodiments, comprises a processor 102, memory 104, storage 106, one or more input devices 108, and one or more output devices 110. The processing system 100, in at least some embodiments, also comprises one or more of an input driver 112 or an output driver 114. In some embodiments, the processing system 100 includes one or more software, hardware, circuitry, and firmware components in addition to or different from those shown in FIG. 1.

In at least some embodiments, the processor 102 comprises a central processing unit (CPU), an accelerator processor (e.g., a graphics processing unit (GPU)), a CPU and an accelerator processor located on the same die or multiple dies (e.g., using a multi-chip-module (MCM)), or one or more processor cores, wherein each processor core is a CPU or an accelerator processor. The memory 104, in at least some embodiments, is located on the same die as the processor 102 or is located separately from the processor 102. The memory 104 includes a volatile or non-volatile memory, such as random-access memory (RAM), dynamic RAM, cache, and so on.

The storage 106, in at least some embodiments, comprises a fixed or removable storage, such as a hard disk drive, a solid-state drive, an optical disk, a flash drive, and so on. In at least some embodiments, the input devices 108 comprise, for example, one or more of a keyboard, a keypad, a touch screen, a touchpad, a detector, a microphone, an accelerometer, a gyroscope, a biometric scanner, a network connection (e.g., a wireless local area network card for transmission/reception of wireless signals), and so on. The output devices 110, in at least some embodiments, comprise, for example, one or more of a display, a speaker, a printer, a haptic feedback device, one or more lights, an antenna, or a network connection (e.g., a wireless local area network card for transmission/reception of wireless signals), and so on.

In at least some embodiments, the input driver 112 communicates with the processor 102 and the input devices 108 and allows the processor 102 to receive input from the input devices 108. The output driver 114, in at least some embodiments, communicates with the processor 102 and the output devices 110 and allows the processor 102 to send output to the output devices 110. It is noted that the processing system 100 operates in the same manner if the input driver 112 and the output driver 114 are not present. The output driver 114, in at least some embodiments, includes an accelerated processing device (APD) 116 that is coupled to a display device 118. The APD 116 accepts compute commands and graphics rendering commands from processor 102, processes those compute and graphics rendering commands, and provides pixel output to display device 118 for display. The APD 116, in at least some embodiments, includes one or more parallel processing units that perform computations in accordance with a single-instruction-multiple-data (SIMD) paradigm.

The processing system 100 also includes a waveguide modeler 120. In at least some embodiments, the waveguide modeler 120 is implemented separate from or as part of one or more processors 102 (e.g., CPU, GPU, a combination thereof, or the like), one or more application-specific integrated circuits/circuitry (ASICs), one or more programmable logic devices, one or more other components of the processing system 100, or a combination thereof. In other embodiments, the waveguide modeler 120 is implemented as software executable on one or more processors 102. In at least some embodiments, the processor 102 configures the waveguide modeler 120 to perform one or more techniques described herein for simulating the optical performance of a diffractive waveguide.

In at least some embodiments, the waveguide modeler 120 is configured to model diffractive waveguides. A diffractive waveguide is a waveguide that implements diffraction gratings. A diffraction grating is an optical element having a periodic structure that diffracts light into several beams traveling in different directions (i.e., different diffraction angles). Stated differently, a diffraction grating separates (disperses) light into its constituent wavelengths (colors) such that each wavelength is diffracted at a slightly different angle. The directions or diffraction angles of the beams depend on the wave (light) incident angle to the diffraction grating, the spacing or distance between adjacent diffracting elements (e.g., grooves, slits, slots, etc.) on the diffraction grating, and the wavelength of the incident light. A diffraction grating is typically either a reflection grating that diffracts light back into the plane of incidence or a transmission grating that transmits dispersed light through the grating.

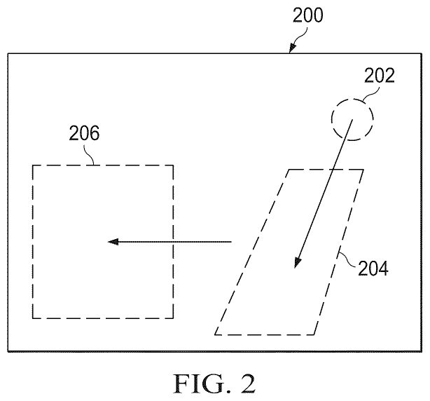

Diffraction gratings are typically implemented as one or more of input couplers (ICs), exit pupil expanders (EPE), or outcouplers (OC) of a waveguide. For example, FIG. 2 illustrates an example configuration of a waveguide 200. In this example, the waveguide employs a first diffraction grating as an IC 202 to receive display light, a second diffraction grating as an EPE 204 to increase the size of the display exit pupil, and third diffraction grating as an OC 206 to direct the resulting display light toward a user's eye. If the pupil of the eye is aligned with one or more exit pupils provided by the OC 206, at least a portion of the light exiting through the OC 206 will enter the pupil of the eye, thereby enabling the user to see a virtual image.

Referring back to FIG. 1, the waveguide modeler 120 is configured to take parameters of a diffractive waveguide 200 as input and, based on this input, simulate the optical performance of the diffractive waveguide 200. Examples of parameters taken as input by the waveguide modeler 120 include geometric properties, material properties, wavelength(s) of light to be propagated through the waveguide 200, boundary conditions, mode or initial field configuration for simulating the propagation of light through the waveguide 200, grating (e.g., IC 202, EPE 204, and OC 206) parameters, grating material properties, and the like. The geometric properties include, for example, the shape and size of the waveguide 200, such as length, width, and height. The material properties include, for example, the refractive indices of the materials used in the waveguide, as well as any wavelength dependence of the refractive index (dispersion). Boundary conditions specify how the field behaves at the boundaries of the waveguide 200. Grating parameters include, for example, the period of the grating (the distance between similar points in the structure), the shape of the grating (e.g., square, sinusoidal, sawtooth), the duty cycle (the ratio of the width of the “teeth” to the period), and the depth or thickness of the grating. Grating material properties include, for example, the refractive indices of the materials used in the grating.

As described in greater detail below, the waveguide modeler 120 efficiently and accurately simulates the optical performance of a diffractive waveguide 200 by integrating both diffractive grating modeling to model the wave optics effect and ray tracing to model the refractive optics effect. For example, given an input light ray having a specified wavelength(s) and projected on the IC 202 of the waveguide 200 at a specified field angle, the waveguide modeler 120 performs diffractive grating modeling for each grating structure (e.g., IC 202, an EPE 204, and OC 206) to generate a set of transfer matrices 122. The set of transfer matrices 122 relates the electric field of one bounce a light ray makes on the waveguide 200 or grating surface to the electric field of neighboring bounces. The waveguide modeler 120 performs the diffractive grating modeling process for a plurality of input light rays each having a different wavelength(s), and for each input light ray projected at a plurality of different field angles. The waveguide modeler 120 also performs a ray tracing process for the input light ray and uses the set of transfer matrices to output a set of E-fields 124 for each light ray outcoupled by the OC of the waveguide. The waveguide modeler 120 then generates a pupil efficiency uniformity map 126 based on the set of output E-fields 124 generated during the ray tracing process for each of the plurality of input light rays field angles. The pupil efficiency uniformity map 126 provides a quantification of the waveguide's efficiency. For example, the pupil efficiency uniformity map 126 indicates, for different sampled pupil positions and field angles, the brightness of the outcoupled light rays, the color and brightness uniformity of the outcoupled light rays, and the like. In at least some embodiments, the waveguide modeler 120 generates a graphical representation of the pupil efficiency uniformity map 126 to visualize the efficiency of the waveguide 200.

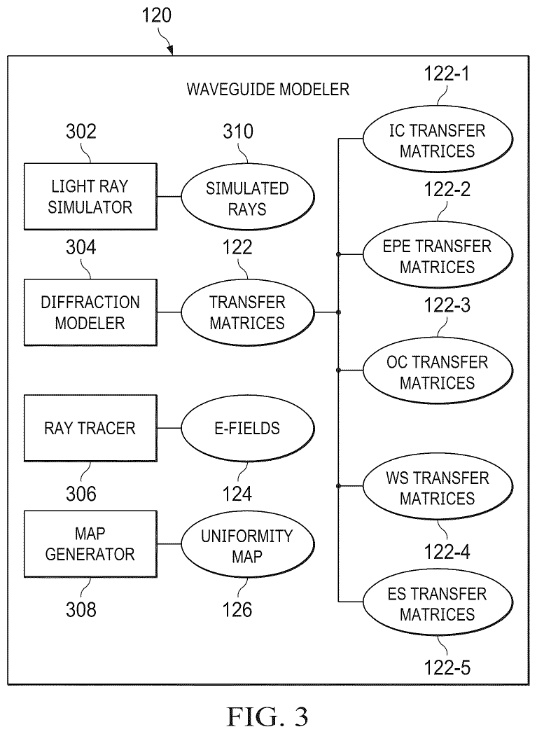

FIG. 3 shows a more detailed view of the waveguide modeler 120. In at least some embodiments, the waveguide modeler 120 comprises a light ray simulator 302, a diffraction modeler 304, a ray tracer 306, and a uniformity map generator 308. As described in greater detail below, the light ray simulator 302 generates simulated light rays 310 (also referred to herein as “input light rays 210”) for simulating the optical performance of a waveguide. In at least some embodiments, two or more of these components are combined into a single component of the waveguide modeler 120.

The light ray simulator 302 simulates a plurality of input light rays 310, each having a different wavelength or range of wavelengths. For example, the light ray simulator 302 simulates a first input light ray 310 having a red light wavelength(s), a second input light ray 310 having a blue light wavelength(s), and a third input light ray 310 having a green light wavelength(s). The light ray simulator 302 also simulates each of the input light rays 310 at different field angles of interest, which are the angles at which an input light ray is incident on the IC 202 (or coupled into the IC) of the waveguide 200 being modeled. For example, if a range of field angles to be considered during the waveguide modeling is 0 to 50 degrees, the light ray simulator 302, in at least some embodiments, simulates the input ray 310 at each of the field angles (or a subset thereof). In other words, the light ray simulator 302 generates a first input light ray 310 having a first wavelength and projects this light ray 310 onto the IC 202 of the waveguide 200 being modeled at a first field angle. The light ray simulator 302 then simulates another instance of the first input light ray 310 as being projected at another field angle. This process is repeated until the first input light ray has been simulated as being projected onto the IC 202 for each of the field angles of interest (or a subset thereof). A similar process is also performed for each input light ray 310 having a different wavelength(s). In at least some embodiments, the light ray simulator 302 also simulates multiple instances of an input light ray 310 with different intensities.

The diffraction modeler 304 executes one or more computational techniques, such as RCWA, on each grating structure of the waveguide 200 being modeled and models the diffraction of the grating structures. In at least some embodiments, the diffraction modeler 304 takes, as input, the characteristics of the input light ray 310 (i.e., the incident light) and the grating structure that the light interacts with. These parameters define the optical problem to be solved. The incident light input includes, for example, the wavelength(s) of the light, the angle(s) of incidence (the direction from which the light is coming), the polarization state(s) (either transverse electric (TE), where the electric field is perpendicular to the plane of incidence, or transverse magnetic (TM, where the magnetic field is perpendicular to the plane of incidence), and the intensity or amplitude of the light. In at least some embodiments, the light ray simulator 302 generates one or more simulated light rays 310 that are used by the diffraction modeler 304, or the diffraction modeler 304 obtains the characteristics of the incident light rays from the light ray simulator 302. The grating structure input includes, for example, the geometrical parameters (e.g., shape, size, and periodicity of the features), the refractive index of the materials in the grating (which might be a function of position within the grating, if there are multiple materials), and the number of periods of the grating to be considered. In at least some embodiments, the grating is one-dimensional (varying in one direction) or two-dimensional (varying in two directions), and has any number of layers.

The diffraction modeler 304 takes the input and calculates the diffracted fields (reflected and transmitted) of the grating structure being modeled. For example, the diffraction modeler 304 defines the grating structure and incident wave by specifying the geometry, material properties, and periodicity of the grating structure, as well as the properties of the incident wave, such as its wavelength and angle of incidence. The diffraction modeler 304 then discretizes the grating structure by dividing the structure into layers along the direction of propagation. Each layer can have a different permittivity and permeability, but within each layer, these properties are assumed to be constant. The diffraction modeler 304 expands the permittivity distribution and electromagnetic fields (E-fields) within each layer into Fourier series, due to the periodicity of the grating structure. The diffraction modeler 304 determines boundary conditions for the E-fields at the interfaces between layers. These conditions are derived from Maxwell's equations and ensure that the E-fields are continuous across the interfaces. The diffraction modeler 304 calculates the E-field within each layer using the Fourier expansions and the boundary conditions. In at least some embodiments, this is performed by setting up and solving a system of linear equations, typically using matrix methods. For example, a matrix is created for the E-fields at the top and bottom of each layer. The matrix includes the coefficients of the Fourier expansions of the E-fields. Then, for each layer, the diffraction modeler 304 forms and solves an eigenvalue problem from the matrix formulation. This process yields the propagation constants (eigenvalues) and modal profiles (eigenvectors) of the modes within the layer. The diffraction modeler 304 calculates the transfer matrix of each layer, which propagates the E-fields from the bottom to the top of the layer, using the eigenvalues and eigenvectors. Then, the diffraction modeler 304 calculates the transfer matrix 122 of the whole grating structure by multiplying the layer matrices together. In at least some embodiments, the transfer matrix 122 of the whole grating structure is output by the diffraction modeling process and used as an input to the ray tracing process described below. From the transfer matrix of the whole structure, the diffraction modeler 304 calculates the E-fields that are reflected from and transmitted through the grating structure by applying the transfer matrix to the incident field. In at least some embodiments, the reflected and transmitted E-fields are also output by the diffraction modeling process, which can be used to calculate quantities of interest, such as diffraction efficiencies, reflectance, transmittance, and so on of the grating structure. In other embodiments, the diffraction modeler 304 stops the diffraction modeling process after the transfer matrix 122 of the whole grating structure is generated.

The diffraction modeling process described above is iteratively performed for each grating structure of the waveguide based on each input light ray 310 simulated by the light ray simulator 302 and each instance of the input light rays 310 projected at different field angles. For example, consider the waveguide 200 of FIG. 2 and a first input light ray 310 having a first wavelength(s), a second input light ray 310 having a second wavelength(s), and a third input light ray 310 having a third wavelength(s). In at least some embodiments, the diffraction modeler 304 models the IC 202 by performing a plurality of iterations of the modeling process for each of the first input light ray 310, the second input light ray 310, and the third input light ray 310. Each iteration of the plurality of iterations models the diffraction of the IC 202 given the same input light ray 310 but with a different field/incident angle. For example, the diffraction modeler 304 performs a first iteration of the diffraction modeling process for the IC 202 based on the first input light ray 310 projected at a first field angle and generates a first transfer matrix 122 for the IC 202 based thereon. The diffraction modeler 304 then performs additional iterations of the diffraction modeling process for the IC 202, with each additional iteration projecting the first input light ray 310 at a different field angle, and generates additional transfer matrices 122 for the IC 202 based thereon. Additional iterations are then performed for each of the second input light ray 310 and the third input light ray 310. The diffraction modeler 304 repeats this process for each of the EPE 204 and the OC 206. As such, the diffraction modeler 304 generates a first plurality of transfer matrices 122-1 for the IC 202, a second plurality of transfer matrices 122-2 for the EPE 204, and a third plurality of transfer matrices 122-3 for the OC 206. In at least some embodiments, the diffraction modeler 304 also generates one or more transfer matrices 122-4 for the internal world side-facing area of the waveguide 200 without a grating surface (also referred to herein as “world side background area”) and one or more transfer matrices 122-5 for the internal eye side facing area of the waveguide 200 without a grating surface (also referred to herein as “eye side background area”).

The ray tracer 306 performs a ray tracing process for each input light ray 310 to simulate the propagation of the input light ray 310 through the waveguide 200 being modeled. In at least some embodiments, the ray tracing process is an iterative process that is performed for each input light ray 310, each instance of the input light rays 310 projected at different field angles, and each incident ray position of a plurality of incident ray positions (e.g., spatial positions on the IC 202 at which the input light rays 310 first contact the IC 202). In at least some embodiments, the ray tracing process performed by the ray tracer 306 is based on deterministic ray tracing and takes into consideration the unique physics of the waveguide 200, i.e., coherent combination of rays during propagations, to continually degenerate rays during the ray tracing. The concept of a “node” is used to determine the coherence state of the ray. For light sources, such as light-emitting diodes (LEDs), rays arriving at the same node have identical optical path lengths (OPLs) and are summed coherently, whereas rays at different nodes have different OPLs and are summed incoherent. Also, in at least some embodiments, one or more diffraction orders that have a low diffraction efficiency are ignored during the ray tracing process. For example, the 0^{th} order reflection on the world side background area of the waveguide 200 having an anti-reflective coating, the +/−2^{nd} order of the IC 202, and the +2^{nd} order of the OC 206 can also be disregarded. However, in other embodiments, one or more of these orders are considered during the ray tracing process.

In at least some embodiments, the input taken by ray tracer 306 includes, for example, one or more of the initial conditions, wave structure information, material properties, boundary conditions, and the like. The initial conditions include the incident position (starting position) and field angle (direction) of the input light ray 310 being traced. The initial conditions, in at least some embodiments, also include the wavelength and polarization of the input light ray 310. The waveguide structure information includes information regarding the structure and geometry of the waveguide 200 being modeled, such as the shape, size, and thickness of the waveguide. In at least some embodiments, the waveguide structure information also includes information regarding any variations in the waveguide's structure, such as bends, tapers, or irregularities. The material properties include information about the optical properties of the materials that make up the waveguide 200 being modeled, such as the refractive index of each material. In at least some embodiments, the material properties also include information regarding any variations in the material properties, such as gradations in the refractive index. The boundary conditions indicate the behavior of light rays at the boundaries of the waveguide 200. For example, the boundary conditions include information about how light is reflected or transmitted at the boundaries and special conditions, such as periodic or absorbing boundaries.

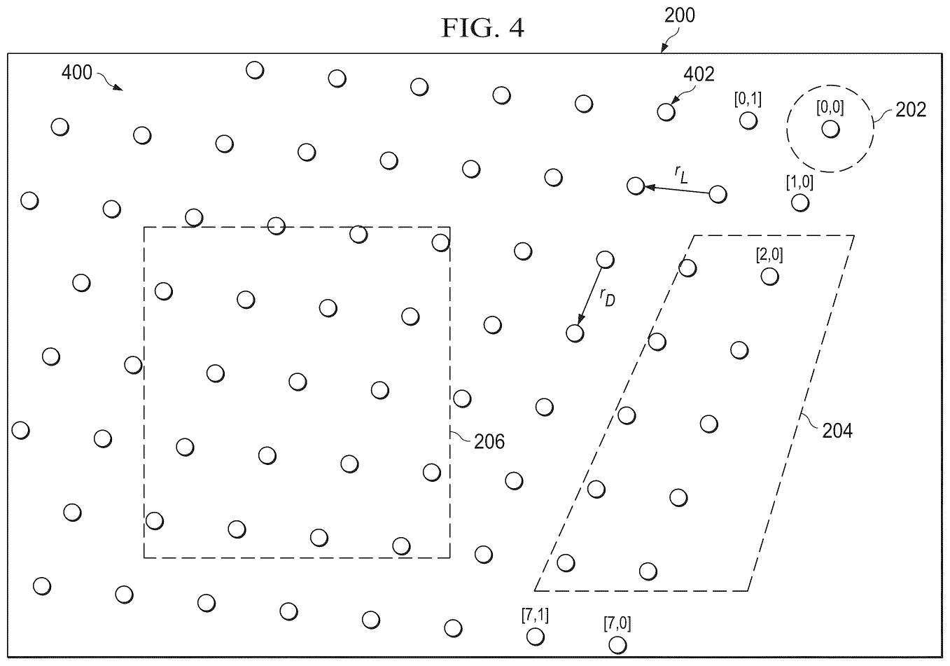

In at least some embodiments, the input light ray 310 is represented as ray ( [symbol] ᵢ, [symbol] ᵢ), where [symbol] ᵢ is the incident direction vector (also referred to here as “k-vector” or “wave vector”) and [symbol] ᵢis the incident coordinate on the IC 202. The k-vector of a light ray corresponds to or illustrates a direction in which the light ray propagates through a waveguide. Given the input light ray 310, ray ( [symbol] ᵢ, [symbol] ᵢ), the ray tracer 306 generates a grid of nodes where the input light ray 310 intersects the waveguide 200 and grating surfaces (e.g., IC 202, EPE 204, and OC 206). Stated differently, each bounce the input light ray 310 makes on the waveguide 200 or grating surface is a node in the grid of nodes. FIG. 4 shows one example of a grid 400 of nodes 402 for the waveguide 200 of FIG. 2 representing where an input light ray intersects the waveguide 200 and surfaces of the IC 202, EPE 204, and OC 206.

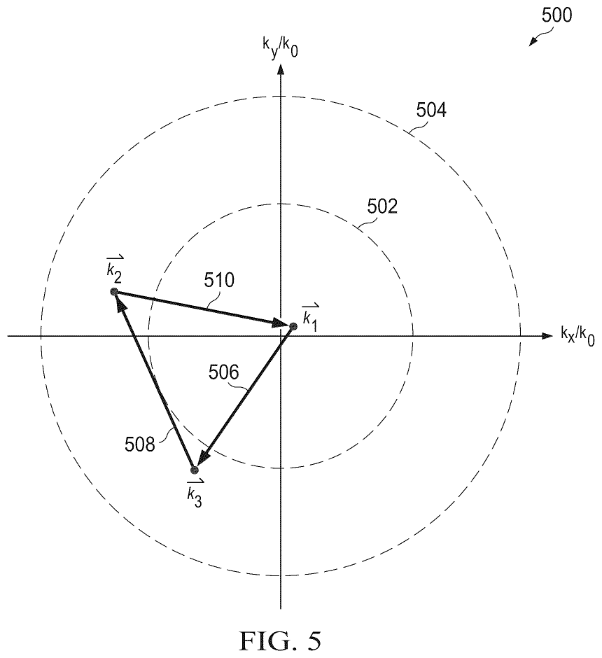

In at least some embodiments, the ray tracer 306 determines the positions of the nodes 402 in the grid 400 using a k-space diagram generated for the waveguide. FIG. 5 shows one example of a k-space diagram 500 representing display light propagating through a waveguide, such as the waveguide 200 of FIG. 2. A k-space diagram is a tool used in optical design to represent directions of light rays that propagate within a waveguide. Stated differently, a k-space diagram shows the angles at which light is coupled into a waveguide. In the k-space diagram 500, an inner refractive boundary 502 is depicted as a circle with radius of n=1, the refractive index associated with the external transmission medium (air). An outer refractive boundary 504 corresponds to an effective refractive index of the medium of the waveguide 200. In the context of the k-space diagram 500, for red, green, blue (RGB) display light to be successfully and accurately directed to an eye of a user via the waveguide 200 with the indicated refractive index, each red, green, and blue component of that display light enters the waveguide system from an external position 506, which is included in the space depicted within inner refractive boundary 502. The color components are directed along one or more paths within the waveguide 200 via total internal reflection (TIR) (light that undergoes TIR within the waveguide 200 resides in the space depicted between inner refractive boundary 502 and outer refractive boundary 504) and are then redirected to exit the waveguide 200 (and thereby return to the external space within inner refractive boundary 502 within which light does not undergo TIR). Display light components represented between the inner refractive boundary 502 and outer refractive boundary 504 are propagated to the user via the waveguide 200. Any display light components represented outside the outer refractive boundary 504 (of which there are none in the k-space representation 500) are non-propagating and cannot exist.

Initially, display light entering the waveguide 200 at the incoupler forms an image that is centered at or around the origin of the k-space representation 500. The image is initially disposed at a first position 506 with respect to k-space. Upon redirection of the display light by the IC 202, the image is shifted in k-space to a second position 508, corresponding to a shift in the negative k_{y} and kₓ dimensions. Upon redirection of the display light by the EPE 204, the image is shifted in k-space to a third position 510, corresponding to a shift in the positive k_{y} dimension and the negative kₓ dimension. Upon redirection of the display light by the OC 206, the image is shifted in k-space back to the first position 506, corresponding to a shift in the positive kₓ dimension. In the present example, it is assumed that the angle at which the display light enters the waveguide system via the IC 202 is the same as or substantially the same as (e.g., within 5% of) the angle at which the display light exits the waveguide 200 via the OC 206.

In at least some embodiments, the ray tracer 306 obtains the angles at which light propagates through the waveguide based on the k-space diagram 500 and uses these propagation angles to determine the position in x-space (real space) at which a light ray hits the surface of the waveguide structure and surfaces of the IC 202, EPE 204, and OC 206. The ray tracer 306, in at least some embodiments, calculates the propagation angle(s) of an input light ray 310 based on the k-vector(s) of the ray 310 obtained from the k-space diagram 500. For example, consider a k-vector obtained for an input light ray 310 at the projector (light source) output represented as:

$${\vec{k}}_{1} = [ {k}_{1 x} , {k}_{1 x} , {k}_{1 z} ] = n {k}_{0} , with {k}_{1 z} < 0 , \qquad ( EQ . 1 )$$

where k₀ is the k-vector in vacuum and n is the refractive index of the material through which the light ray is traveling.

The k-vector [symbol] ₁ is described in terms of its Cartesian components (kₓ, k_{y}, k_{z}) representing the light ray's spatial frequencies along the x, y, and z axes. The ray tracer 306 normalizes the k-vector [symbol] ₁ to the k-vector k₀ in a vacuum as follows:

$${\hat{k}}_{1} = \frac{{\vec{k}}_{1}}{\vert {\vec{k}}_{0} \vert} = [ \frac{{k}_{1 x}}{\vert {\vec{k}}_{0} \vert} , \frac{{k}_{1 y}}{\vert {\vec{k}}_{0} \vert} , \frac{{k}_{1 z}}{\vert {\vec{k}}_{0} \vert} ] . \qquad ( EQ . 2 )$$

Therefore, the magnitude |\hat{k}₁| of the normalized k-vector \hat{k}₁ has the magnitude of the refractive index, which is air for the projector output:

$$\vert {\hat{k}}_{1} \vert = {n}_{air} . \qquad ( EQ . 3 )$$

The ray tracer 306 then obtains the direction cosine [symbol] _{c1} of the light ray from the components (\hat{k}₁ₓ, \hat{k}_{1y}, \hat{k}_{1z}) of the normalized vector \hat{k}₁ as follows:

$${\vec{d}}_{c 1} = \frac{{\hat{k}}_{1}}{{n}_{air}} = [ cos {a}_{1} , cos {b}_{1} , cos {c}_{1} ] . \qquad ( EQ . 4 )$$

where

$$cos {a}_{1} = \frac{{k}_{1 x}}{\vert {\vec{k}}_{0} \vert} , \qquad ( EQ . 5 )$$

$$cos {b}_{1} = \frac{{k}_{1 y}}{\vert {\vec{k}}_{0} \vert} , \qquad ( EQ . 6 )$$

$$cos {c}_{1} = \frac{{k}_{1 z}}{\vert {\vec{k}}_{0} \vert} , and \qquad ( EQ . 7 )$$

$${cos}^{2} {a}_{1} + {cos}^{2} {b}_{1} + {cos}^{2} {c}_{1} = 1. \qquad ( EQ . 8 )$$

The directional cosine [symbol] _{c1} is a further scaling of the k-vector [symbol] ₁ such that the magnitude becomes 1 and represents the cosines of the angles the light ray's direction of propagation makes with the x, y, and z axes, respectively, of the waveguide 200.

The ray tracer 306 repeats the above process for the k-vector [symbol] ₂ incident on the EPE 204 of the waveguide 200 and the k-vector [symbol] ₃ incident on the OC 206 of the waveguide 200 to obtain the normalized vectors \hat{k}₂ and \hat{k}₃ and corresponding directional cosines [symbol] _{c2} and [symbol] _{c3}, respectively, as follows:

$${\vec{d}}_{c 2} = \frac{{\vec{k}}_{2}}{{n}_{E P E}} with {\vec{d}}_{c 2} [ 2 ] > 0 , \qquad ( EQ . 9 )$$

where n_{EPE} is the refractive index of the EPE 204 material,

$${\vec{d}}_{c 3} = \frac{{\vec{k}}_{3}}{{n}_{O C}} with {\vec{d}}_{c 3} [ 2 ] > 0 , \qquad ( EQ . 10 )$$

where n_{OC} is the refractive index of the OC material,
[symbol] _{c2}·r represents [symbol] _{c2} reflected by the x-y plane, and
[symbol] _{c3}·r represents [symbol] _{c3} reflected by the x-y plane.

The notation [symbol] _{c2}[2] in EQ. 9 and [symbol] _{c3}[2] in EQ. 10 refers to the third element of the [symbol] _{c2} and [symbol] _{c3}, respectively, such that [symbol] _{c2}[2]=cos c₂ and [symbol] _{c3}[2]=cos c₃. Therefore, [symbol] _{c2}[2]>0 and [symbol] _{c3}[2]>0 indicate that the k-vectors [symbol] ₂ and [symbol] ₃ are pointing towards the z>0 direction (propagating upwards). Otherwise, the k-vectors [symbol] ₂ and [symbol] ₃ are pointing towards the z<0 direction (propagating downwards).

The ray tracer 306 calculates the propagation angle(s) for the input light ray 310 based on the directional cosines determined for the light ray 310. For example, the ray tracer 306 calculates the propagation angle θ₂ of the light ray 310 at the EPE 204 and the propagation angle θ₃ of the light ray 310 at the OC 206 using the inverse cosine function (a cos) as follows:

$${θ}_{2} = a cos {\vec{d}}_{c 2} [ 2 ] , \qquad ( EQ . 11 )$$

$$and$$

$${θ}_{3} = a cos {\vec{d}}_{c 3} [ 2 ] . \qquad ( EQ . 12 )$$

The ray tracer 306, in at least some embodiments, does not calculate the propagation angle(s) for the input light ray 310 at the IC 202 because the direction and propagation of the light ray 310 entering the waveguide through the IC 202 are already known or controlled.

Using the propagation angles, θ₂ and θ₃, and directional cosines, [symbol] _{c2} and [symbol] _{c3}, the ray tracer 306 determines the position of each bounce and the spacing between each bounce that the light ray 310 makes on the waveguide 200, IC 202, EP 204, and OC 206 using, for example, geometric calculations and the law of reflection. The ray tracer 306 generates nodes 402 in the grid 400 based on the determined bounce positions and spacings. Stated differently, node 402 in the gride of nodes 402 represents the x-y position, as calculated based on the k-space diagram 500, at which a light ray hits the surface of the waveguide structure or surfaces of the IC 202, EPE 204, and OC 206. For example, referring to FIG. 4, the nodes 402 are spaced according to a first bounce spacing, r_{D}, in the up-down direction and a second bounce spacing, r_{L}, in the right-to-left direction. The bounce spacings r_{D} and r_{L}, which represent the length of a bounce, are calculated by the ray tracer 306 as follows:

$${r}_{D} = 2 {t}_{o} tan {θ}_{2} , \qquad ( EQ . 13 )$$

where tₒ is the thickness of the waveguide, and

$${r}_{L} = 2 {t}_{o} tan {θ}_{3} . \qquad ( EQ . 14 )$$

The ray tracer 306 also calculates a bounce spacing vector, which represents bounce direction, for each of the bounce spacings r_{D} and r_{L} as follows:

$${\vec{r}}_{D} = {r}_{D} [ cos {ℓ}_{2} , sin {ℓ}_{2} ] , \qquad ( EQ . 15 )$$

where [symbol] ₂ is the azimuth angle of [symbol] _{c2}, and

$${\vec{r}}_{L} = {r}_{L} [ cos {ℓ}_{3} , sin {ℓ}_{3} ] , \qquad ( EQ . 16 )$$

where [symbol] ₃ is the azimuth angle of [symbol] _{c3}.

The azimuth angles [symbol] ₂ and [symbol] ₃ of the directional cosines [symbol] _{c2} and [symbol] _{c3} are the angles in the xy-plane of the waveguide 200 from the positive x-axis towards the positive y-axis. Stated differently, the azimuth angles [symbol] ₂ and [symbol] ₃ give the direction of the light ray 310 in the xy-plane of the waveguide 200. The ray tracer 306 determines the azimuth angles [symbol] ₂ and [symbol] ₃ using an inverse tangent or arctangent function as follows:

$${ℓ}_{2} = a tan 2 ( {\vec{d}}_{c 2} ) , \qquad ( EQ . 17 )$$

$$and$$

$${ℓ}_{3} = a tan 2 ( {\vec{d}}_{c 3} ) . \qquad ( EQ . 18 )$$

The coordinate [i,j] of a node 402 in the grid 400 is denoted as a matrix grid having the shape n×m×2 such that:

$$grid [ i , j ] = [ {x}_{i} , {y}_{j} ] = grid [ 0 , 0 ] + i \cdot {\vec{r}}_{D} + j \cdot {\vec{r}}_{L} \qquad ( EQ . 19 )$$

where grid [0,0] is the incident coordinate of the input light ray on the IC.
As such, starting at the incident node position (e.g., grid coordinate [0, 0]) of the input light ray 310 on the IC 202, the ray tracer 306 determines the position of each node 402 in the grid 400 according to EQ 19. For example, the ray tracer 306 calculates each [xᵢ,yᵢ] position of a node 402 in the indexed [i,j] grid 400 starting from position [0, 0] plus i shifts in the downward direction and j shifts in the leftward direction (grid [0,0]+i· [symbol] _{D}+j· [symbol] _{L}). In at least some embodiments, the ray tracer 306 calculates a grid 400 of nodes 402 for each input light ray 310 simulated with a different field angle.

After the ray tracer 306 generates the grid 400 of nodes 402 for an input light ray 310 having a specified field angle, the ray tracer 306 recursively calculates the E-fields of each node 402 using the transfer matrices 122 generated during the diffraction modeling process. The transfer matrices 122 relate the E-field of one node 402 to its neighboring node(s) 402. As such, the ray tracer 306 determines the E-field of each node 402 by recursively performing matrix multiplication using one or more transfer matrices 122 generated for the IC 202, EPE 204, and OC 206 of the waveguide 200 and neighboring E-fields.

In the following description, transfer matrix T is denoted as T(grating_name, incident_direction, order_number), which is the 3×3 transfer matrix for grating_name at incident_direction with order_number. The incident E-field [symbol] _{inc} is represented as the following 3×1 complex vector:

$${\vec{E}}_{i n c} = {( {E}_{i x} , {E}_{i y} , {E}_{i z} )}^{T} , \qquad ( EQ . 20 )$$

which follows either S polarization such that [symbol] _{inc}=(1,0,0)^{T}, or P polarization [symbol] _{inc}=(0,1,0)^{T}.

The E-field propagating downward (along the 0^{th} order) at node [i,j] is represented as:

$${\vec{E}}_{D} [ i , j ] = [ \begin{matrix}{E}_{x} \\ {E}_{y} \\ {E}_{z}\end{matrix} ] . \qquad ( EQ . 21 )$$

Within the IC 202 area of the grid 400, the ray tracer 306 calculates the downward propagating E-field [symbol] _{D} for the first bounce, which is a single diffraction event, at the grid position [0, 0] as follows:

$${\vec{E}}_{D} [ 0 , 0 ] = T ( IC , {\vec{d}}_{c 1} , 1 ) {\vec{E}}_{i n c} . \qquad ( EQ . 22 )$$

As such, the downward propagating E-field [symbol] _{D} for the first bounce at the IC 202 is calculated by multiplying IC transfer matrix 122-1 (with direction [symbol] _{c1} along the +1 order) by the incident E-field [symbol] _{inc}.

The ray tracer 306 then moves to the next node 402 in the grid 400. If the position, grid [i,j], of this node 402 is within the IC 202 where multiple bounces occur, the ray tracer 306 only tracks the 0^{th} order reflection and calculates the downward propagating E-field [symbol] ₚ for the node 402 as follows:

$${\vec{E}}_{D} [ i , 0 ] = T ( IC , {\vec{d}}_{c 2} , 0 ) T ( W S , {\vec{d}}_{c 2} . r , 0 ) {\vec{E}}_{D} [ i - 1 , 0 ] exp ( i Φ ) \qquad ( EQ . 23 )$$

where WS is the world side background area of the waveguide, i in exp (iΦ) is the imaginary unit, and Φ is the propagation phase along the 0^{th} order direction from node [i−1, 0] to node [i, 0], where:

$$Φ = \vec{k} \cdot \vec{r} = {k}_{0} ( {k}_{x} {r}_{x} + {k}_{y} {r}_{y} + 2 {k}_{z} t ( x , y ) ) , \qquad ( EQ . 24 )$$

and where t(x,y) is the thickness of the waveguide at position (x,y) and

$${k}_{0} = \frac{2 π}{λ} , [ {k}_{x} , {k}_{y} , {k}_{z} ]$$

are the reduced [symbol] vector of the light ray.

As such, the E-field [symbol] _{D} for a node 402 within the area of IC 202 in the grid 400 is calculated by multiplying together the IC transfer matrix 122-1 (with direction [symbol] _{c2} along the 0^{th} order), the WS transfer matrix 122-4 (with reflected direction [symbol] _{c2} along the 0^{th} order), the E-field [symbol] _{D} of the neighboring node 402 at grid position [i−1, 0], and the exponential function of the propagation phase.

If the grid position [i,j] of the node 402 is outside of the IC 202, the ray tracer 306 only tracks 0^{th} order reflection and calculates the downward propagating E-field [symbol] _{D} for the node 402 as follows:

$${\vec{E}}_{D} [ i , 0 ] = T ( E S , {\vec{d}}_{c 2} , 0 ) T ( W S , {\vec{d}}_{c 2} \cdot r , 0 ) {\vec{E}}_{D} [ i - 1 , 0 ] exp ( i Φ ) \qquad ( EQ . 25 )$$

where ES is the eye side background area of the waveguide.

As such, the E-field [symbol] _{D} for a node 402 outside of the IC 202 area in the grid 400 is calculated by multiplying together the ES transfer matrix 122-5 (with direction [symbol] _{c2} along the 0^{th} order), the WS transfer matrix 122-4 (with reflected direction [symbol] _{c2} along the 0^{th} order), the E-field [symbol] _{D} of the neighboring node 402 at grid position [i−1, 0], and the exponential function of the propagation phase.

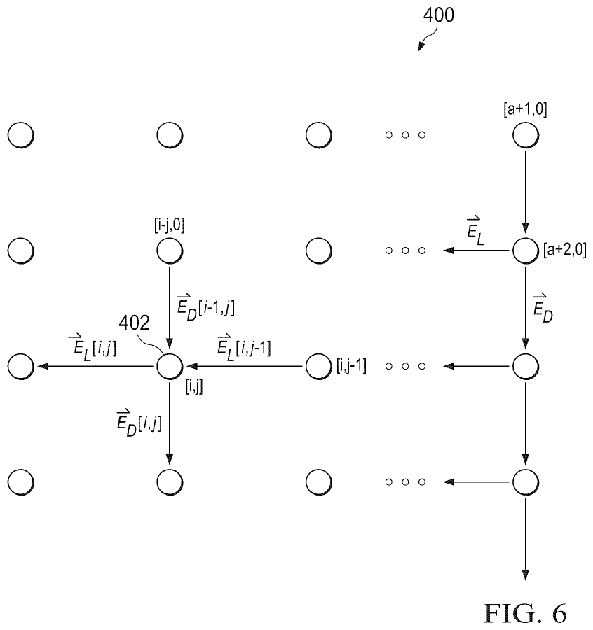

The ray tracer 306 continues stepping through each node 402 in the first column (j=0) and performs the E-field calculation process described above until the next node 402 is within the EPE 204 area of the waveguide 200. In the EPE 204, the E-fields are split into two directions at each node [ij]. For example, FIG. 6 shows a portion of the nodes 402 in the grid 400 of FIG. 4 that is within the EPE 204 area. In this example, the right side of FIG. 6 shows that the E-field of each node 402 within the EPE 204 area is split into two E-fields, a first E-field, [symbol] _{D}, that travels up-to-down (along the 0^{th} order) with direction [symbol] _{c2} and a second E-field, [symbol] _{L}, that travels left-to-right (along the +1 order) with direction [symbol] _{c3}. The left side of FIG. 6 further shows that each node 402 within the EPE 204 area will have two input E-fields, [symbol] _{D} and [symbol] _{L}, and two output E-fields, [symbol] _{D} and [symbol] _{L}. For example, node [i,j] in FIG. 6 receives the E-field [symbol] _{D}[i−1,j] from node [i−1,j] and the E-field [symbol] _{L}[i,j−1] from node [i,j−1], and outputs two E-fields, [symbol] _{D}[i,j] and [symbol] _{L}[i,j]. The interaction at node [i,j] between the two input E-fields is referred to as coherent field summation.

For the first column (j=0) in the grid 400 and starting from i=a+1, every node 402 in the first column that is within the EPE 204 area is only dependent on the node 402 above it. For example, in FIG. 6, the right-most column is the first column (j=0). The E-field for each node 402 in this column of the grid 400 that is within the EPE 204 area is only dependent on the node above it, as there are no nodes 402 to the right of this column that are within the EPE 204 area. Therefore, starting at grid position [a+1, 0], the ray tracer 306 determines the E-fields, [symbol] _{D} and [symbol] _{L}, for each node 402 within the EPE 204 area in the first column (j=0) as follows:

$${\vec{E}}_{D} [ i , 0 ] = T ( E P E , {\vec{d}}_{c 2} , 0 ) T ( W S , {\vec{d}}_{c 2} \cdot r , 0 ) {\vec{E}}_{D} [ i - 1 , 0 ] exp ( i {Φ}_{D} ) , \qquad ( EQ . 26 )$$

$${\vec{E}}_{L} [ i , 0 ] = T ( E P E , {\vec{d}}_{c 2} , 1 ) T ( W S , {\vec{d}}_{c 2} \cdot r , 0 ) {\vec{E}}_{D} [ i - 1 , 0 ] exp ( i {Φ}_{L} ) . \qquad ( EQ . 27 )$$

where Φ_{D} is the downward direction propagation phase of the input light ray 310 and Φ_{L} is the leftward direction propagation phase of the input light ray 310.

As such, the E-field [symbol] _{D} for a node 402 in the first column of the grid 400 within the EPE 204 area is calculated by multiplying together the EPE transfer matrix 122-2 (with direction [symbol] _{c2} along the 0^{th} order), the WS transfer matrix 122-4 (with reflected direction [symbol] _{c2} along the 0^{th} order), the E-field [symbol] _{D} of the neighboring node 402 at grid position [i−1, 0], and the exponential function of the propagation phase along the 0^{th} order. Similarly, the leftward propagating E-field [symbol] _{L} for the node 402 is calculated by multiplying together the EPE transfer matrix 122-2 (with direction [symbol] _{c2} along the +1 order), the WS transfer matrix 122-4 (with reflected direction [symbol] _{c2} along the 0^{th} order), the E-field [symbol] _{D} of the neighboring node 402 at grid position [i−1, 0], and the exponential function of the propagation phase along the +1 order.

For each remaining column in the grid 400, every node 402 that is within the EPE 204 area is dependent on two neighboring nodes 402; that is the node 402 directly above the current node 402 and the node 402 directly to the right of the current node 402. For example, in FIG. 6, the E-fields of node [i,j] are dependent on the E-field of node [i−1,j] and the E-field from node [i,j−1]. Therefore, for each subsequent column (j=0+b, where b>0) after the first column (j=0), the ray tracer 306 determines the E-fields, [symbol] _{D} and [symbol] _{L}, for each node 402 within the EPE 204 area as follows:

$${\vec{E}}_{D} [ i , j ] = T ( E P E , {\vec{d}}_{c 2} , 0 ) T ( W S , {\vec{d}}_{c 2} \cdot r , 0 ) {\vec{E}}_{D} [ i - 1 , j ] exp ( i {Φ}_{D} ) + T ( E P E , {\vec{d}}_{c 3} , - 1 ) T ( W S , {\vec{d}}_{c 3} \cdot r , 0 ) {\vec{E}}_{L} [ i , j - 1 , j ] exp ( i {Φ}_{L} ) , \qquad ( EQ . 28 )$$

$${\vec{E}}_{L} [ i , j ] = T ( E P E , {\vec{d}}_{c 2} , 1 ) T ( W S , {\vec{d}}_{c 2} \cdot r , 0 ) {\vec{E}}_{D} [ i - 1 , j ] exp ( i {Φ}_{D} ) + T ( E P E , {\vec{d}}_{c 3} , 0 ) T ( W S , {\vec{d}}_{c 3} \cdot r , 0 ) {\vec{E}}_{L} [ i , j - 1 ] exp ( i {Φ}_{L} ) , \qquad ( EQ . 29 )$$

where EQ. 28 can be rewritten as:

$${\vec{E}}_{0} [ i , j ] = {T}_{00} {\vec{E}}_{0} [ i - 1 , j ] exp ( i {Φ}_{0} ) + {T}_{10} {\vec{E}}_{1} [ i , j - 1 ] exp ( i {Φ}_{1} ) , \qquad ( EQ . 30 )$$

and EQ. 29 can be rewritten as:

$${\vec{E}}_{1} [ i , j ] = {T}_{01} {\vec{E}}_{0} [ i - 1 , j ] exp ( i {Φ}_{0} ) + {T}_{11} {\vec{E}}_{1} [ i , j - 1 ] exp ( i {Φ}_{1} ) , \qquad ( EQ . 31 )$$

where Tₘₙ is the transfer matrix from the m^{th} order direction [symbol] ₘ[i−1,j] to the n^{th} order direction [symbol] ₙ[i,j], Φₘ is the propagation phase along the m^{th} order direction from node [i−1,j] to node [i,j],

As such, the E-field [symbol] _{D} for a node 402 in a subsequent column of the grid 400 within the EPE 204 area is calculated by summing the product of multiplying together the EPE transfer matrix 122-2 (with direction [symbol] _{c2} along the 0^{th} order), the WS transfer matrix 122-4 (with reflected direction [symbol] _{c2} along the 0^{th} order), the E-field [symbol] _{D} of the neighboring node 402 at grid position [i−1,j], and the exponential function of the propagation phase along the 0^{th} order with the product of multiplying together the EPE transfer matrix 122-2 (with direction [symbol] _{c3} along the −1 order), the WS transfer matrix 122-4 (with reflected direction [symbol] _{c3} along the 0^{th} order), the E-field [symbol] _{L} of the neighboring node 402 at grid position [i,j−1], and the exponential function of the propagation phase along the +1 order. Similarly, the leftward propagating E-field [symbol] _{L} for the node 402 is calculated by summing the product of multiplying together the EPE transfer matrix 122-2 (with direction [symbol] _{c2} along the +1 order), the WS transfer matrix 122-4 (with reflected direction [symbol] _{c2} along the 0^{th} order), the E-field [symbol] _{D} of the neighboring node 402 at grid position [i−1,j], and the exponential function of the propagation phase along the 0^{th} order with the product of multiplying together the EPE transfer matrix 122-2 (with direction [symbol] _{c3} along the 0^{th} order), the WS transfer matrix 122-4 (with reflected direction [symbol] _{c3} along the 0^{th} order), the E-field [symbol] _{L} of the neighboring node 402 at grid position [i,j−1], and the exponential function of the propagation phase along the +1 order.

When a node 402 in the grid 400 is outside of the EPE 204 area (and OC 206 area), such as node [7,0] or [7,1] in FIG. 4, total internal reflection (TIR) occurs. Therefore, for these nodes 402, the ray tracer 306 calculates the E-fields as follows:

$${\vec{E}}_{D} [ i , j ] = T ( E S , {\vec{d}}_{c 2} , 0 ) T ( W S , {\vec{d}}_{c 2} \cdot r , 0 ) {\vec{E}}_{D} [ i - 1 , j ] exp ( i {Φ}_{D} ) , \qquad ( EQ . 32 )$$

$${\vec{E}}_{L} [ i , j ] = T ( E S , {\vec{d}}_{c 2} , 0 ) T ( W S , {\vec{d}}_{c 3} \cdot r , 0 ) {\vec{E}}_{L} [ i , j - 1 ] exp ( i {Φ}_{L} ) . \qquad ( EQ . 33 )$$

As such, the downward propagating E-field [symbol] _{D} for a node 402 in a subsequent column of the grid 400 that is outside of the EPE 204 area (and OC 206 area) is calculated by multiplying together the ES transfer matrix 122-5 (with direction [symbol] _{c2} along the 0^{th} order), the WS transfer matrix 122-4 (with reflected direction [symbol] _{c2} along the 0^{th} order), the E-field [symbol] _{D} of the neighboring node 402 at grid position [i−1,j] and the exponential function of the propagation phase along the 0^{th} order. Similarly, the leftward propagating E-field [symbol] _{L} for the node 402 is calculated by multiplying together the EPE transfer matrix 122-2 (with direction [symbol] _{c2} along the 0^{th} order), the WS transfer matrix 122-4 (with reflected direction [symbol] _{c3} along the 0^{th} order), the E-field [symbol] _{L} of the neighboring node 402 at grid position [i,j−1], and the exponential function of the propagation phase along the +1 order.

The ray tracer 306 continues stepping through each node 402 in each subsequent column and performs the E-field calculation process described above until the next node 402 is within the OC 206 area of the waveguide 200. In the OC 206, the E-fields can propagate in three directions:
0^{th} order-from left to right, denoted by [symbol] _{L}[i,j],
+1 order Transmissive (T)—outcouple to eye side, denoted by [symbol] ₒᵤₜ[i,j], and
+1 order Reflective (R)—outcouple to world side, denoted by [symbol] _{world}[i,j].

In at least some embodiments, the E-field [symbol] _{world}[i,j] is not considered by the ray tracer 306. In these embodiments, the ray tracer 306 calculates the output E-fields 124 of the nodes 402 within the OC area 206 as follows:

$${\vec{E}}_{L} [ i , j ] = T ( O C , {\vec{d}}_{c 3} , 0 ) T ( W S , {\vec{d}}_{c 3} \cdot r , 0 ) {\vec{E}}_{L} [ i , j - 1 ] exp ( i {Φ}_{L} ) , \qquad ( EQ . 34 )$$

$${\vec{E}}_{out} [ i , j ] = T ( O C , {\vec{d}}_{c 3} , 1 ) T ( W S , {\vec{d}}_{c 3} \cdot r , 0 ) {\vec{E}}_{L} [ i , j - 1 ] exp ( i {Φ}_{L} ) . \qquad ( EQ . 35 )$$

As such, the E-field [symbol] _{L} for a node 402 within the OC 206 area is calculated by multiplying together the OC transfer matrix 122-3 (with direction [symbol] _{c3} along the 0^{th} order), the WS transfer matrix 122-4 (with reflected direction [symbol] _{c3} along the 0^{th} order), the E-field [symbol] _{L} of the neighboring node 402 at grid position [i,j−1], and the exponential function of the propagation phase along the +1 order. Similarly, the output E-field [symbol] ₒᵤₜ is calculated by multiplying together the OC transfer matrix 122-3 (with direction [symbol] _{c3} along the +1 order), the WS transfer matrix 122-4 (with reflected direction [symbol] _{c3} along the 0^{th} order), the E-field [symbol] _{D} of the neighboring node 402 at grid position [i,j−1], and the exponential function of the propagation phase along the +1 order. In at least some embodiments, the output of the ray tracer 306 is the [symbol] ₒᵤₜ electric fields 124 for an input light ray 310 have a specified wavelength, field of view, incident position on the IC 202, and polarization. The [symbol] ₒᵤₜ electric fields 124 represent the near-field distribution of the replicated pupils. The uniformity of the near-field over the OC 206 determines the eyebox non-uniformity.

In at least some embodiments, after the ray tracer 306 outputs the [symbol] ₒᵤₜ electric fields 124 of the outcoupling nodes 402 of the OC 204 for the current iteration, the ray tracer 306 repeats the ray tracing process described above for the input light ray 310 but with a different polarization. For example, after the ray tracer 306 determines the [symbol] ₒᵤₜ electric fields 124 for an input ray 310 having Wavelength_1, FOV_1, IncidentPos_1, and Polarization_S, the ray tracer 306 repeats the raytracing process for this input ray 310 but for Polariation_P. Therefore, in at least some embodiments, the ray tracer 306 outputs two sets of [symbol] ₒᵤₜ electric fields 124 for an instance of input light ray 310 (e.g., an input light ray having a specified wavelength, field angle, and incident position) comprised of a first set sets of [symbol] ₒᵤₜ electric fields 124 based on S polarization and a second set of sets of [symbol] ₒᵤₜ electric fields 124 based on P polarization. If the display being modeled is unpolarized, the ray tracer 306 sums the two sets of [symbol] electric fields 124. The [symbol] electric fields 124 provide information such as the wavelength, the propagation direction, intensity, and polarization of the outcoupled ray. Stated differently, the [symbol] electric fields 124 gathers all the information associated with the light that is directed into the eyebox (the box where the user's pupil is located). The [symbol] electric fields 124 can be used to render the displayed image, predict the distribution of color and brightness over the FOV or across different locations of the eyebox, and the like.

The ray tracer 306 performs additional iterations of the ray tracing process for the current input light ray 310 to output [symbol] ₒᵤₜ electric fields 124 based on each remaining incident ray position of the plurality of incident ray positions. Then, the ray tracer 306 repeats the ray tracing process for the current input light ray 310 but for a different field angle and each incident ray position of the plurality of incident ray positions. After the ray tracer 306 completes the ray tracing process for the current input light ray 310 and each field angle, the ray tracer 306 performs the iterative ray tracing process for a new input light ray 310 having a different wavelength until the ray tracer 306 has generated the [symbol] ₒᵤₜ electric fields 124 for all input light rays 310, including the [symbol] ₒᵤₜ electric fields 124 for each instance of the input light rays 310 projected at different field angles and at each incident ray position of the plurality of incident ray positions.

It should be understood that although the ray tracing process was described above with respect to one-dimensional (1D) grating structures, the ray tracing process is also applicable to two-dimensional (2D) grating structures. For a 2D grating structure, the ray tracer 306 considers six diffraction orders (00, 10, 01, 22, 21, and 12) between the inner refractive boundary and the outer refractive boundary of the corresponding k-space diagram, where every two orders are connected by a transfer matrix. The nodes 402 in a grid 400 generated for a waveguide comprising a 2D grating structure form a six-dimensional matrix denoted by index [i, j, k, o, p, q]. As such, instead of the E-fields 124 of a node 402 in the grid 400 being dependent upon two neighboring nodes, as for the 1D grating, the E-fields 124 are now dependent upon six neighboring nodes 402.

The ray tracer 306 determines the node positions in the grid 400 from a K-space diagram according to:

$$r [ i , j , k , o , p , q ] = i \cdot {r}_{00} + j \cdot {r}_{10} + k \cdot {r}_{01} + o \cdot {r}_{22} + P \cdot {r}_{21 +} 1 \cdot {r}_{12} , \qquad ( EQ . 36 )$$

where rₘₙ is the bounce vector along the mn order. Also, instead of two propagation directions, [symbol] ₀ (e.g., [symbol] _{D}) and [symbol] ₁ (e.g., [symbol] _{L}) at each node in a 1D grating, a 2D grating has seven different propagation directions on each node denoted by the following E-field vectors: [symbol] ₀₀, [symbol] ₁₀, [symbol] ₀₁, [symbol] ₁₁, [symbol] ₂₁, [symbol] ₁₂, [symbol] ₂₂. The ray tracer 306 performs the ray tracing process described above according to the following near-field recursive update rule to obtain the [symbol] ₒᵤₜ electric fields 124 at the OC 206:

$$\vec{E} [ i , j , k , o , p , q ] = {T}_{i} \vec{E} [ i - 1 , j , k , o , p , q ] + {T}_{j} \vec{E} [ i , j - 1 , k , o , p , q ] + {T}_{k} \vec{E} [ i , j , k - 1 , o , p , q ] + {T}_{o} \vec{E} [ i , j , k , o - 1 , p , q ] + {T}_{p} \vec{E} [ i , j , k , o , p - 1 , q ] + {T}_{q} \vec{E} [ i , j , k , o , p , q - 1 ] . \qquad ( EQ . 37 )$$

Also, because tracking six orders can become computationally expensive, the ray tracer 306, in at least some embodiments, reduces the computational expense by eliminating rays from the ray tracing process that have a flux lower than a specified threshold.

In at least some embodiments, the map generator 308 receives the [symbol] ₒᵤₜ electric fields 124 generated by the ray tracer 306 and generates a pupil efficiency uniformity map 126 based on the [symbol] ₒᵤₜ electric fields 124. The pupil efficiency uniformity map 126 provides a quantification of the waveguide's efficiency. For example, the pupil efficiency uniformity map 126 indicates, for different sampled pupil positions and field angles, the brightness of the outcoupled light rays, the color and brightness uniformity of the outcoupled light rays, and the like.

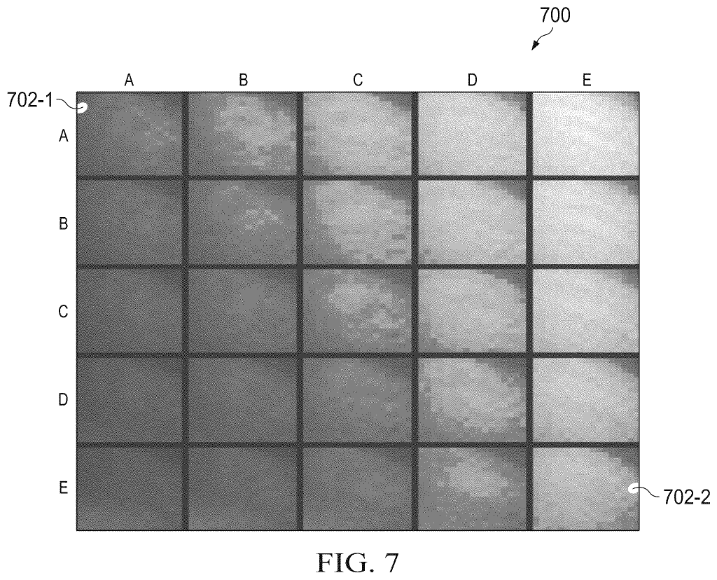

FIG. 7 shows one example of a pupil efficiency uniformity map 726 generated by the map generator 308 based on the [symbol] ₒᵤₜ electric fields 124 output by the ray tracing process described above. In this example, a graphical representation of a pupil efficiency uniformity map 726 is generated by the map generator 308 to visualize the efficiency of the waveguide 200. Each block 702 within the map 700 represents an image as seen by the pupil at a different sampled pupil position. For example, block 702-1 represents an image generated by the map generator 308 based on the [symbol] ₒᵤₜ electric fields 124 for pupil position AA, whereas block 702-2 represent an image generated by the map generator 308 based on the [symbol] ₒᵤₜ electric fields 124 for pupil position EE. Each block 702 is associated with an output power P, which corresponds to the efficiency of the waveguide for that pupil position. The output power P is the E-field squared and integrated over the pupil area/position. For another pupil position, there is another output power P. Therefore, as shown in the FIG. 7, some blocks 702 are brighter than other blocks since the output power P is dependent upon the pupil position. The output power P is also dependent on the outcoupling angle of the light ray. As such, the same pupil position within the map 726 has a different efficiency/power for different outcoupling angles.

In at least some embodiments, the map generator 308 calculates the output power P for each pupil position of a pupil efficiency uniformity map 126 by integrating the Poynting vector inside a pupil projected onto the waveguide surface as follows:

$${P}_{out} = \int {\int }_{pupil} {S}_{z} dxdy = \int {\int }_{pupil} {\vert {\vec{E}}_{out} \vert}^{2} dxdy = {\sum }_{i , j ∈ pupil} {\vert {\vec{E}}_{out} [ i , j ] \vert}^{2} , \qquad ( EQ . 38 )$$

where S_{z} is the Poynting vector along the z direction. In at least some embodiments, the integral is over intensity instead of the E-field because, for some light sources, such as light emitting diodes (LEDs), different points on the exit pupil of the light engine are incoherent and different nodes on the OC are incoherent. The waveguide modeler 120, in at least some embodiments, calculates the efficiency of the waveguide for a given pupil position as:

$${η}_{eff} = \frac{{P}_{out}}{{P}_{in}} , \qquad ( EQ . 39 )$$

where

$${P}_{in} = \int {\int }_{EP} {\vert {\vec{E}}_{inc} \vert}^{2} dxdy . \qquad ( EQ . 40 )$$

For unpolarized performance, the waveguide modeler 120 takes the average of efficiencies generated by S and P polarized incident field.

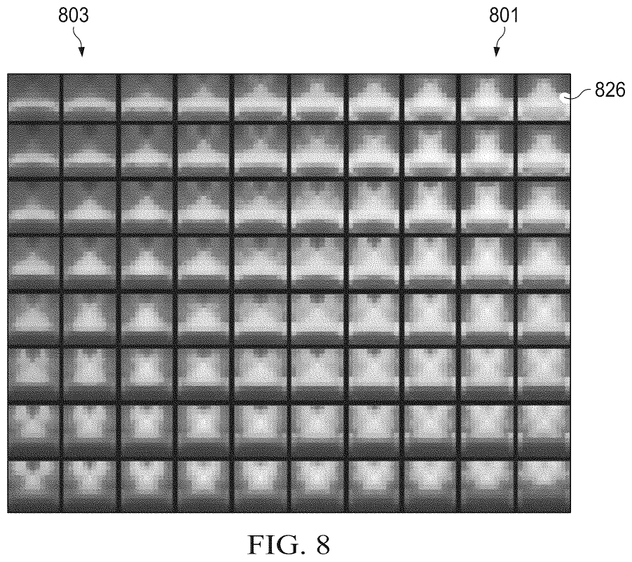

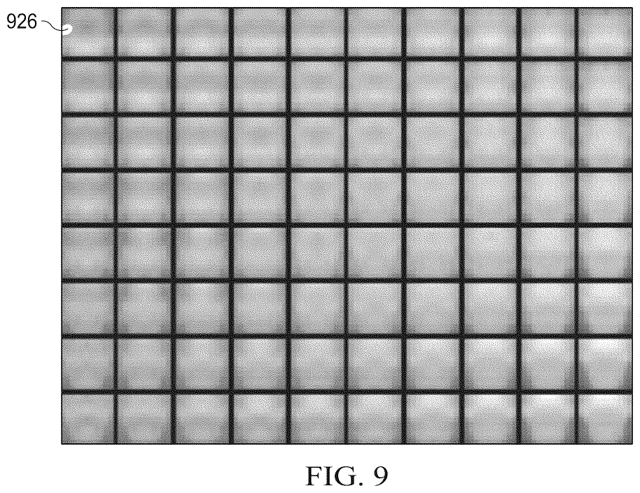

In at least some embodiments, the pupil efficiency uniformity map 126 is used to adjust the design parameters of the waveguide 200 and its components, such as the grating structures, to increase the performance of the waveguide 200. For example, FIG. 8 shows another example of a pupil efficiency uniformity map 826. The map 826 is a chromaticity map of a waveguide having poor color uniformity calculated based on the [symbol] ₒᵤₜ electric fields 124 output by the ray tracing process described above. In this example, the target waveguide display is gray but the waveguide outputs blueish light (represented by the lighter shading) in the right portion 801 of the eyebox and orangish light (represented by the darker shading) in the left portion 803 eyebox together with non-uniformity across the FOV in the same eyebox location. As such, based on the color non-uniformity determined from the map 826, one or more waveguide design parameters can be adjusted to improve, the color uniformity over the eyebox and FOV, as shown in the pupil efficiency uniformity map 926 of FIG. 9.

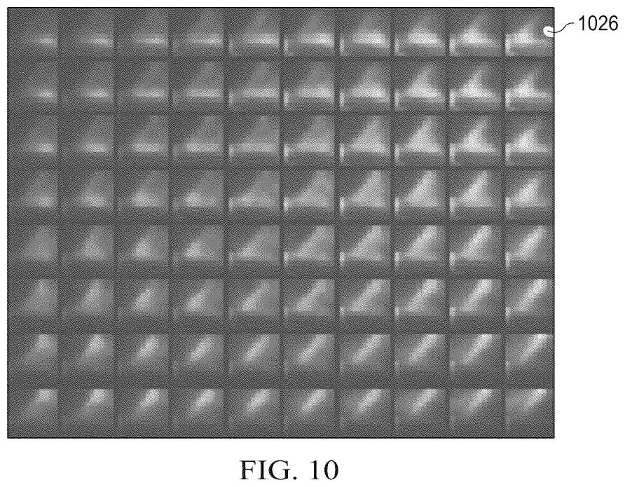

FIG. 10 shows another example of a pupil efficiency uniformity map 1026. In this example, the map 1026 is a luminance map of a waveguide having poor brightness uniformity calculated based on the [symbol] ₒᵤₜ electric fields 124 output by the ray tracing process described above. The map 1026 shows that the waveguide display is brighter towards the temple (upper left) direction and dimmer towards the nasal (lower right) direction. There is also brightness non-uniformity across the FOV in the same eyebox location. As such, based on the brightness non-uniformity determined from the map 1026, one or more waveguide design parameters can be adjusted to improve brightness uniformity over the eyebox and FOV, as shown in the pupil efficiency uniformity map 1126 of FIG. 10.

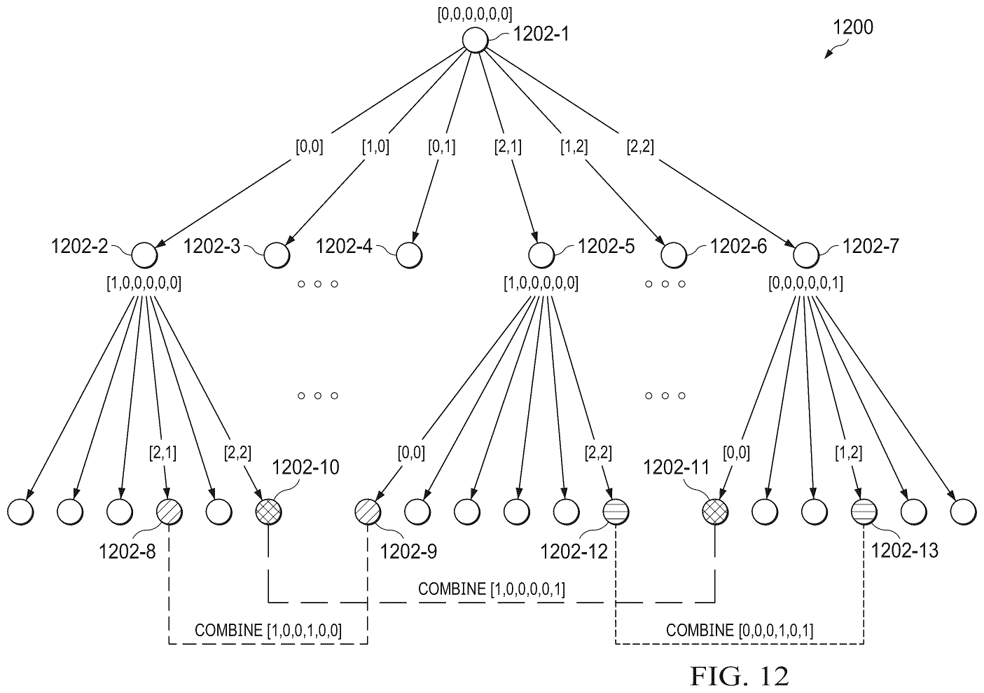

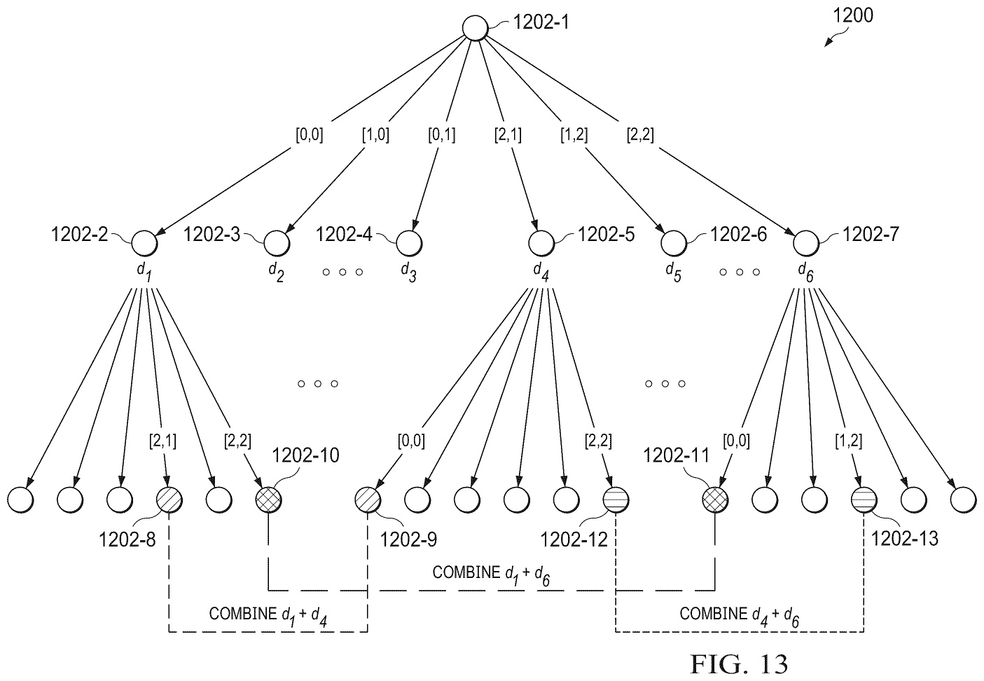

In at least some embodiments, the ray tracer 306 is configured to represent light ray bounces using mechanisms other than the grid 400 of FIG. 4. FIG. 12 shows one example of these additional mechanisms. In FIG. 12, light ray bounces for a waveguide implementing 2D grating structures are represented using a tree configuration. For example, FIG. 12 shows a tree 1200 generated for light bounces having an incident (root) node 1202. Every bounce branches one node 1202 of the tree 1200 into six children nodes 1202. For example, FIG. 12 shows that the incident node 1202-1 is branched into six child nodes 1202-2 to 1202-7. The number of child nodes is determined by the number of diffraction orders the grating at parent node position (x,y) has. Each of the nodes 1202 in the tree 1200 is associated with a node coordinate (e.g., [0,0,0,0,0,0] and each branch is associated with a diffraction order (e.g., [1,0]). Each child node 1202 generated by a bounce has eight outgoing orders including six guided orders and two out-coupled orders. Therefore, one light ray is uniquely represented by a row vector [x, y, i, j. k. o, p, q, u, v, [symbol] ₓ, [symbol] _{y}, [symbol] _{z}], where (x,y) is the location of the node 1202, (i,j,k,o,p,q) is the counter of bounces in each direction in x space, (u,v) is the diffraction order in k-space, and ( [symbol] ₓ, [symbol] _{y}, [symbol] _{z}) is the complex E-field vector. As shown in FIG. 13, in at least some embodiments, the (i,j,k,o,p,q) portion of a node's row vector is replaced by the optical path length d as follows:

$$[ x , y , i , j \cdot k \cdot o , p , q , u , v , \text{} {\vec{E}}_{x} , {\vec{E}}_{y} , {\vec{E}}_{z} ] \text{} = \text{} [ x , y , d , u , v , {\vec{E}}_{x} , {\vec{E}}_{y} , {\vec{E}}_{z} ] , \qquad ( EQ . 41 )$$

and the condition for coherent addition becomes Δd<coherence length.

The ray tracer 306 traverses the tree 1200 by calculating a child node 1202 E-field from its parent node 1202. For example, the E-field for child node 1202-8 is calculated as:

$$\vec{E} [ {x}_{1} , {y}_{1} , 1 , 0 , 0 , 1 , 0 , 0 , u , v ] = {T}_{21 \to uv} \vec{E} [ x , y , 1 , 0 , 0 , 0 , 0 , 0 , 2 , 1 ] or \qquad ( EQ . 42 )$$

$$\vec{E} [ {x}_{1} , {y}_{1} , {d}_{1} + {d}_{4} , u , v ] = {T}_{21 \to uv} \vec{E} [ x , y , {d}_{1} , 2 , 1 ] , \qquad ( EQ . 43 )$$

where T_{21→uv} is the transfer matrix from (2,1) order to (u,v) order.
The E-field for child node 1202-9 is calculated as:

$$\vec{E} [ {x}_{1} , {y}_{1} , 1 , 0 , 0 , 1 , 0 , 0 , u , v ] = {T}_{00 \to uv} \vec{E} [ {x}_{2} , {y}_{2} , 0 , 0 , 0 , 1 , 0 , 0 , 0 , 0 ] or \qquad ( EQ . 44 )$$

$$\vec{E} [ {x}_{1} , {y}_{1} , {d}_{4} + {d}_{1} , u , v ] = {T}_{00 \to uv} \vec{E} [ {x}_{2} , {y}_{2} , {d}_{4} 0 , 0 ] . \qquad ( EQ . 45 )$$

If (x,y) is outside of the grating area (e.g., the corresponding polygon in FIG. 2), the ray tracer 306 does not generate the row (level) of the tree 1200. In each layer of the tree 1200, the ray tracer 306 detects the rows with the same index [i, j, k, o, p, q, u, v] or [d, u, v]. For example, child nodes 1202-8 and 1202-9 have the same index, child nodes 1202-10 and 1202-11 have the same index, and child nodes 1201-12 and 1202-13 have the same index. The ray tracer 306 combines the child nodes (rows) having the same index by adding the last three columns [ [symbol] ₓ, [symbol] _{y}, [symbol] _{z}] of the nodes, which reduces the number of rows before expanding the next layer of the tree 1200. In at least some embodiments, if ray tracer 306 determines that the power of a light ray is less than a threshold (e.g., | [symbol] |²<ε, the ray tracer 306 deletes the row. In other words, the ray tracer 306 stops tracing a light ray if its power is less than a specified threshold ε.

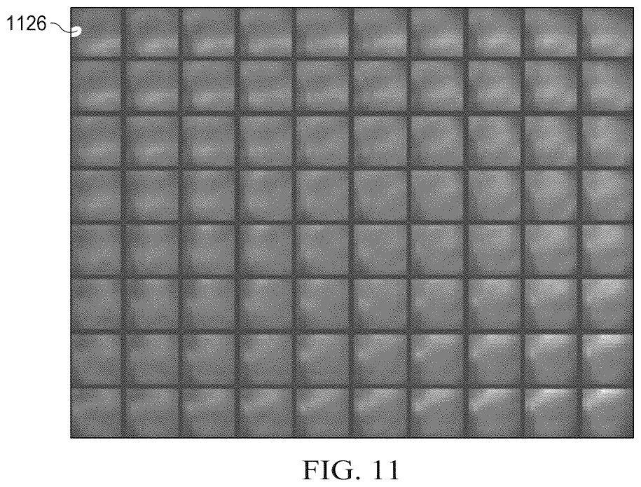

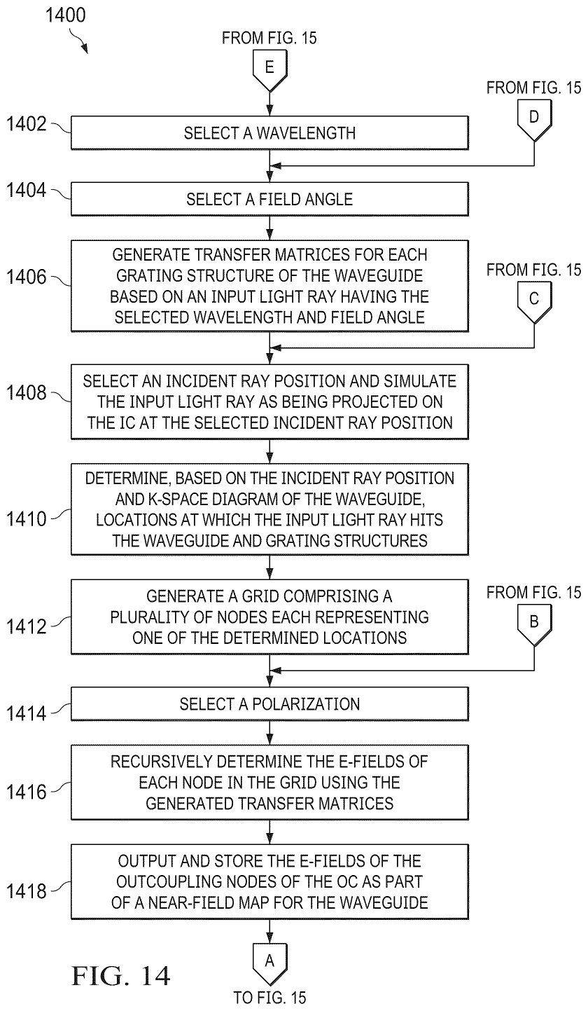

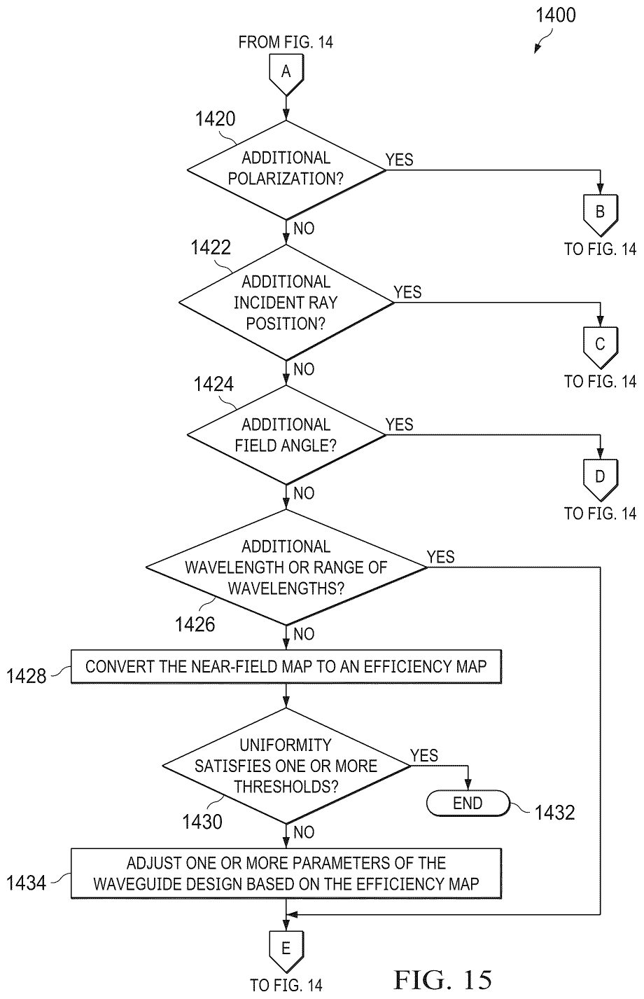

FIG. 14 and FIG. 15 together illustrate an example method 1400 for performing one or more of the techniques described herein to efficiently and accurately simulate the optical performance of a diffractive waveguide. It should be understood that the processes described below with respect to method 1400 have been described above in greater detail with reference to FIG. 1 to FIG. 13. The method 1400 is not limited to the sequence of operations shown in FIG. 14 and FIG. 15, as at least some of the operations can be performed in parallel or in a different sequence. Moreover, in at least some implementations, the method 1400 can include one or more different operations than those shown in FIGS. 14 and 15.

At block 1402, the waveguide modeler 120 selects a characteristic, such as a wavelength or range of wavelengths, for an input light ray 310. At block 1404, the waveguide modeler 120 selects another characteristic, such as a field angle, for the input light ray 310. At block 1406, the waveguide modeler 120 executes one or more computational techniques, such as RCWA, on each grating structure of the waveguide 200 being modeled and models the diffraction of the grating structures based on an input light ray 310 having the selected wavelength and field angle. This process generates a set of transfer matrices 122 for each grating structure (e.g., IC 202, EPE 204, and OC 206) of the waveguide 200. At block 1408, the waveguide modeler 120 initiates a ray tracing process and selects another characteristic, such as incident ray position, for the input light ray 310. The waveguide modeler 120 simulates the input light ray 310 having the selected wavelength and field angle as being projected on the IC 202 of the waveguide being modeled 200 at the incident ray position.

At block 1410, the waveguide modeler 120 determines the bounce positions at which the input light ray 310 hits waveguide structure, IC 202, EPE 204, and OC 206. As described above, with respect to FIG. 3 to FIG. 5, the waveguide modeler 120 determines the bounces of the input light ray based on the incident position and the k-space diagram 500 associated with the waveguide 200 according to EQ. 2 to EQ. 19. At block 1412, the waveguide modeler 120 generates a grid 400 (or tree) of nodes 402 with each node 402 representing a bounce position. Stated differently, the position of a node 402 in the grid 400 corresponds to one of the bounce positions determined for the input light ray.

At block 1414, the waveguide modeler 120 selects another characteristic, such as polarization, for the input light ray 310. At block 1416, the waveguide modeler 120 steps through the nodes 402 in the grid 400 and recursively determines the E-field(s) for each node 402 using the set of transfer matrices 122 generated at block 1406 and according to EQ. 20 to EQ. 37. At block 1418, the waveguide modeler 120 outputs the set of E-fields 124 of the outcoupling nodes 402 calculated for the OC 206 of the waveguide 200. This set of E-fields 124 is stored as part of a near-field map generated for the waveguide 200 being modeled. At block 1420, if the waveguide modeler 120 determines that there is an additional polarization to be considered, the process returns to block 1414, and the waveguide modeler 120 selects another polarization for the input light ray 310. The waveguide modeler 120 then steps through the nodes 402 and recursively determines the E-field(s) for each node 402 based on the input light ray 310 having the newly selected polarization.

At block 1422, if all polarizations have been considered, the waveguide modeler 120 determines if all incident ray positions for the input light ray 310 have been considered. If at least one incident ray position remains to be considered, the process returns to block 1408, and the waveguide modeler 120 selects a new incident position for the input light ray 310. The processes at block 1410 to block 1422 are then repeated for the input light ray 310 projected at the newly selected incident position. At block 1424, if all incident ray positions have been considered, the waveguide modeler 120 determines if all field angles for the input light ray 310 have been considered. If at least one field angle remains to be considered, the process returns to block 1404, and the waveguide modeler 120 selects a new field angle for the input light ray 310. The processes at block 1406 to block 1424 are then repeated for the input light ray 310 simulated at the newly selected field angle. At block 1426, if all field angles have been considered, the waveguide modeler 120 determines if all wavelengths or ranges of wavelengths have been considered. If at least one wavelength or range of wavelengths remains to be considered, the process returns to block 1402, and the waveguide modeler 120 selects a new wavelength or range of wavelengths. The processes at block 1404 to block 1426 are then repeated using input light ray 310 having the newly selected wavelength or range of wavelengths. As such, multiple iterations of the diffraction process at block 1406 are performed for each diffractive grating of the waveguide 200 based on each input light ray 310 with a different combination of wavelength and field angle.

At block 1428, if all wavelengths or ranges of wavelengths have been considered, the near-field map, which has been generated based on all of the E-fields 124 output at block 1418 for all input light ray instances (e.g., different wavelengths, field angles, and incident ray positions), is converted to a pupil efficiency uniformity map 126 (far-field map) according to EQ. 38 to EQ. 40. At block 1430, the waveguide modeler 120 (or another component or system) uses the uniformity map 126 to determine if the uniformity of one or more attributes (e.g., color or brightness) of the waveguide 200 satisfies at least one uniformity threshold. At block 1432, if the uniformity satisfies the at least one uniformity threshold, the process ends. At block 1434, if the uniformity does not satisfy the at least one uniformity threshold, one or more design parameters of the waveguide 200 are adjusted and process returns to block 1402.

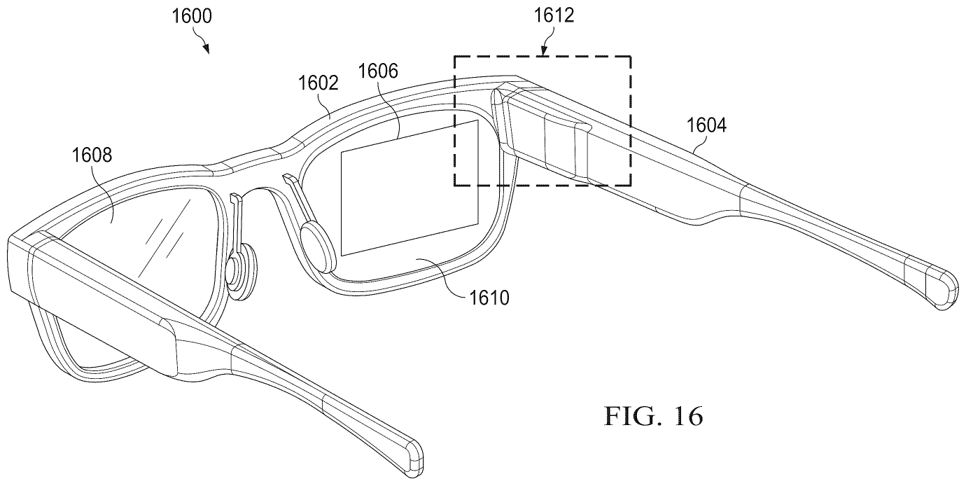

FIG. 16 illustrates an example display system 1600, such as a near-to-eye device or a wearable head mounted display (HMD), capable of implementing a waveguide designed based on one or more of the waveguide optical performance simulation techniques described herein. It should be noted that, although the apparatuses and techniques described herein are not limited to this particular example, but instead may be implemented in any of a variety of display systems using the guidelines provided herein. In at least some embodiments, the display system 1600 comprises a support structure 1602 that includes an arm 1604, which houses an image source, such as laser projection system, configured to project images toward the eye of a user such that the user perceives the projected images as being displayed in FOV area 1606 of a display at one or both of lens elements 1608, 1610. In the depicted embodiment, the display system 1600 is a near-eye display system that includes the support structure 1602 configured to be worn on the head of a user and has a general shape and appearance of an eyeglasses frame. The support structure 1602 includes various components to facilitate the projection of such images toward the eye of the user, such as a laser projector, an optical scanner, and a waveguide, such as the waveguide 200 described above with respect to FIG. 1 to FIG. 15. In at least some embodiments, the support structure 1602 further includes various sensors, such as one or more front-facing cameras, rear-facing cameras, other light sensors, motion sensors, accelerometers, and the like. The support structure 1602 further can include one or more radio frequency (RF) interfaces or other wireless interfaces, such as a Bluetooth™ interface, a Wireless Fidelity (WiFi) interface, and the like.

Further, in at least some embodiments, the support structure 1602 includes one or more batteries or other portable power sources for supplying power to the electrical components of the display system 1600. In at least some embodiments, some or all of these components of the display system 1600 are fully or partially contained within an inner volume of support structure 1602, such as within the arm 1604 in region 1612 of the support structure 1602. It should be noted that while an example form factor is depicted, it will be appreciated that in other embodiments, the display system 1600 may have a different shape and appearance from the eyeglasses frame depicted in FIG. 16.

One or both of the lens elements 1608, 1610 are used by the display system 1600 to provide an augmented reality (AR) or a mixed reality (MR) display in which rendered graphical content is superimposed over or otherwise provided in conjunction with a real-world view as perceived by the user through the lens elements 1608, 1610. For example, laser light used to form a perceptible image or series of images may be projected by a laser projector of the display system 1600 onto the eye of the user via a series of optical elements, such as a waveguide (e.g., the waveguide 200) formed at least partially in the corresponding lens element, one or more scan mirrors, and one or more optical relays. Thus, one or both of the lens elements 1608, 1610 include at least a portion of a waveguide that routes display light received by an input coupler, or multiple input couplers, of the waveguide to an output coupler of the waveguide, which outputs the display light toward an eye of a user of the display system 1600. The display light is modulated and scanned onto the eye of the user such that the user perceives the display light as an image. In addition, each of the lens elements 1608, 1610 is sufficiently transparent to allow a user to see through the lens elements to provide a field of view of the user's real-world environment such that the image appears superimposed over at least a portion of the real-world environment.

In at least some embodiments, the projector is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The projector, in at least some embodiments, includes multiple laser diodes (e.g., a red laser diode, a green laser diode, and a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In at least some embodiments, the controller controls a scan area size and scan area location for the projector and is communicatively coupled to a processor (not shown) that generates content to be displayed at the display system 1600. The projector scans light over a variable area, designated the FOV area 1606, of the display system 1600. The scan area size corresponds to the size of the FOV area 1606, and the scan area location corresponds to a region of one of the lens elements 1608, 1610 at which the FOV area 1606 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
generating a plurality of transfer matrices for each diffractive grating of the plurality of diffractive gratings and background areas of the waveguide responsive to performing a diffraction modeling process for a plurality of diffractive gratings of a waveguide based on a plurality of input light rays each having at least a different first characteristic;
determining a plurality of electric fields at outcoupling positions of an outcoupling grating of the plurality of diffractive gratings based on the plurality of transfer matrices responsive to performing a ray tracing process for multiple instances of each input light ray of the plurality of input light rays with at least a different second characteristic; and
generating a uniformity map for the waveguide based on the plurality of electric fields, the uniformity map indicating a uniformity of one or more characteristics of the waveguide across different sampled pupil positions.

2. The method of claim 1, further comprising:
adjusting one or more design parameters of the waveguide to increase the uniformity responsive to determining that the uniformity of at least one of the one or more characteristics of the waveguide fails to satisfy a uniformity threshold based on the uniformity map.

3. The method of claim 1, wherein the at least first different characteristic comprises one or more wavelengths and field angle.

4. The method of claim 1, wherein the at least second different characteristic comprises one or more of:
an incident position on an incoupling grating of the plurality of diffractive gratings,
or polarization.

5. The method of claim 1, wherein generating the plurality of transfer matrices for each diffractive grating comprises performing Rigorous Coupled-Wave Analysis for each diffractive grating of the plurality of diffractive gratings based on each input light ray of the plurality of input light rays with a different combination of wavelength and field angle.

6. The method of claim 1, wherein the ray tracing process comprises:
for each instance of each input light ray of the plurality of input light rays having at least a different incident ray position on an incoupling grating of the plurality of diffractive gratings:
determine a plurality of bounce positions on the waveguide and the plurality of diffractive gratings.

7. The method of claim 6, wherein the plurality of bounce positions is determined based on a k-space diagram for the waveguide.

8. The method of claim 6, wherein the ray tracing process comprises further comprises:
generating a grid of nodes, each node representing a bounce position of the plurality of bounce positions.

9. The method of claim 8, wherein determining the plurality of electric fields at the outcoupling positions of the outcoupling grating comprises:
for nodes within an area of the grid corresponding to the incoupling grating:
calculating a downward propagating electric field for a node in the grid corresponding to an incident position of the input light ray based on an incident electric field and a first transfer matrix of the plurality of transfer matrices generated for the incoupling grating; and
calculating a downward propagating electric field for each remaining node in the area of the grid corresponding to the incoupling grating based on a second transfer matrix of the plurality of transfer matrices generated for the incoupling grating, a third transfer matrix of the plurality of transfer matrices generated for a world side background area of the waveguide, a downward propagating electric field of a neighboring node, and a propagation phase of the input light ray.

10. The method of claim 9, wherein determining the plurality of electric fields at the outcoupling positions of the outcoupling grating further comprises:
for nodes within an area of the grid outside of the incoupling grating but before an exit-pupil-expander grating of the plurality of diffractive gratings, calculating a downward propagating electric field based on a fourth transfer matrix of the plurality of transfer matrices generated for an eye side background area of the waveguide, the third transfer matrix, a downward propagating electric field of a neighboring node, and a propagation phase of the input light ray.

11. The method of claim 10, wherein determining the plurality of electric fields at the outcoupling positions of the outcoupling grating further comprises:
for nodes within a first column of the grid and within an area of the grid corresponding to the exit-pupil-expander grating:
calculating a downward propagating electric field based on a fifth transfer matrix of the plurality of transfer matrices generated for the exit-pupil-expander grating, the third transfer matrix, a downward propagating electric field of a neighboring node, and a downward direction propagation phase of the input light ray; and
calculating a leftward propagating electric field based on a sixth transfer matrix of the plurality of transfer matrices generated for the exit-pupil-expander grating, the second transfer matrix, the downward propagating electric field of the neighboring node, and a leftward direction propagation phase of the input light ray.

12. The method of claim 11, wherein determining the plurality of electric fields at the outcoupling positions of the outcoupling grating further comprises:
for nodes within other columns of the grid and within the area of the grid corresponding to the exit-pupil-expander grating:
calculating a downward propagating electric field based on the fifth transfer matrix, the third transfer matrix, a downward propagating electric field of a first neighboring node, the downward direction propagation phase of the input light ray, a seventh transfer matrix of the plurality of transfer matrices generated for the exit-pupil-expander grating, an eighth transfer matrix of the plurality of transfer matrices generated for the world side background area, a leftward propagating electric field of a second neighboring node, and the leftward direction propagation phase of the input light ray; and
calculating a leftward propagating electric field based on the sixth transfer matrix, the third transfer matrix, the downward propagating electric field of the first neighboring node, the downward direction propagation phase of the input light ray, a ninth transfer matrix of the plurality of transfer matrices generated for the exit-pupil-expander grating, the eighth transfer matrix, the leftward propagating electric field of the second neighboring node, and the leftward direction propagation phase of the input light ray.

13. The method of claim 12, wherein determining the plurality of electric fields at the outcoupling positions of the outcoupling grating further comprises:
for nodes within an area of the grid that is outside of the exit-pupil-expander:
calculating a downward propagating electric field based on the fourth transfer matrix, the third transfer matrix, a downward propagating electric field of a neighboring node, and the downward direction propagation phase of the input light ray; and
calculating a leftward propagating electric field based on a tenth transfer matrix of the plurality of transfer matrices generated for the eye side background area, the eighth transfer matrix, a leftward propagating electric field of the neighboring node, and the leftward direction propagation phase of the input light ray.

14. The method of claim 13, wherein determining the plurality of electric fields at the outcoupling positions of the outcoupling grating further comprises:
for nodes within an area of the grid corresponding to the outcoupling grating:
calculating a leftward propagating electric field based on an eleventh transfer matrix of the plurality of transfer matrices generated for the outcoupling grating, the eighth transfer matrix, a leftward propagating electric field of a neighboring node, and the leftward direction propagation phase of the input light ray; and
calculating an output electric field based on a twelfth transfer matrix of the plurality of transfer matrices generated for the outcoupling grating, the eighth transfer matrix, the leftward propagating electric field of a neighboring node, and the leftward direction propagation phase of the input light ray,
wherein the output electric field generated for each node in the area of the grid corresponding to the outcoupling grating is included in the plurality of electric fields.

15. A processing system comprising:
a processor;
a waveguide modeler configured by the processor to:
generate a plurality of transfer matrices for each diffractive grating of the plurality of diffractive gratings and background areas of the waveguide responsive to a diffraction modeling process performed for a plurality of diffractive gratings of a waveguide based on a plurality of input light rays each having at least a different first characteristic;
determine a plurality of electric fields at outcoupling positions of an outcoupling grating of the plurality of diffractive gratings based on the plurality of transfer matrices responsive to a ray tracing process performed for multiple instances of each input light ray of the plurality of input light rays with at least a different second characteristic; and
generate a uniformity map for the waveguide based on the plurality of electric fields, the uniformity map indicating a uniformity of one or more characteristics of the waveguide across different sampled pupil positions.

16. The processing system of claim 15, wherein the waveguide modeler is configured to perform the ray tracing process by:
for each instance of each input light ray of the plurality of input light rays having at least a different incident ray position on an incoupling grating of the plurality of diffractive gratings:
determine a plurality of bounce positions on the waveguide and the plurality of diffractive gratings; and
generating a grid of nodes, each node representing a bounce position of the plurality of bounce positions.

17. The processing system of claim 16, wherein determining the plurality of electric fields at the outcoupling positions of the outcoupling grating comprises:
for nodes within an area of the grid corresponding to the incoupling grating:
calculating a downward propagating electric field for a node in the grid corresponding to an incident position of the input light ray based on an incident electric field and a first transfer matrix of the plurality of transfer matrices generated for the incoupling grating;
calculating a downward propagating electric field for each remaining node in the area of the grid corresponding to the incoupling grating based on a second transfer matrix of the plurality of transfer matrices generated for the incoupling grating, a third transfer matrix of the plurality of transfer matrices generated for a world side background area of the waveguide, a downward propagating electric field of a neighboring node, and a propagation phase of the input light ray; and
for nodes within an area of the grid outside of the incoupling grating but before an exit-pupil-expander grating of the plurality of diffractive gratings, calculating a downward propagating electric field based on a fourth transfer matrix of the plurality of transfer matrices generated for an eye side background area of the waveguide, the third transfer matrix, a downward propagating electric field of a neighboring node, and a propagation phase of the input light ray.

18. The processing system of claim 17, wherein determining the plurality of electric fields at the outcoupling positions of the outcoupling grating further comprises:
for nodes within a first column of the grid and within an area of the grid corresponding to the exit-pupil-expander grating:
calculating a downward propagating electric field based on a fifth transfer matrix of the plurality of transfer matrices generated for the exit-pupil-expander grating, the third transfer matrix, a downward propagating electric field of a neighboring node, and a downward direction propagation phase of the input light ray;
calculating a leftward propagating electric field based on a sixth transfer matrix of the plurality of transfer matrices generated for the exit-pupil-expander grating, the second transfer matrix, the downward propagating electric field of the neighboring node, and a leftward direction propagation phase of the input light ray;
for nodes within other columns of the grid and within the area of the grid corresponding to the exit-pupil-expander grating:
calculating a downward propagating electric field based on the fifth transfer matrix, the third transfer matrix, a downward propagating electric field of a first neighboring node, the downward direction propagation phase of the input light ray, a seventh transfer matrix of the plurality of transfer matrices generated for the exit-pupil-expander grating, an eighth transfer matrix of the plurality of transfer matrices generated for the world side background area, a leftward propagating electric field of a second neighboring node, and the leftward direction propagation phase of the input light ray; and
calculating a leftward propagating electric field based on the sixth transfer matrix, the third transfer matrix, the downward propagating electric field of the first neighboring node, the downward direction propagation phase of the input light ray, a ninth transfer matrix of the plurality of transfer matrices generated for the exit-pupil-expander grating, the eighth transfer matrix, the leftward propagating electric field of the second neighboring node, and the leftward direction propagation phase of the input light ray.

19. The processing system of claim 18, wherein determining the plurality of electric fields at the outcoupling positions of the outcoupling grating further comprises:
for nodes within an area of the grid that is outside of the exit-pupil-expander:
calculating a downward propagating electric field based on the fourth transfer matrix, the third transfer matrix, a downward propagating electric field of a neighboring node, and the downward direction propagation phase of the input light ray;
calculating a leftward propagating electric field based on a tenth transfer matrix of the plurality of transfer matrices generated for the eye side background area, the eighth transfer matrix, a leftward propagating electric field of the neighboring node, and the leftward direction propagation phase of the input light ray;
for nodes within an area of the grid corresponding to the outcoupling grating:
calculating a leftward propagating electric field based on an eleventh transfer matrix of the plurality of transfer matrices generated for the outcoupling grating, the eighth transfer matrix, a leftward propagating electric field of a neighboring node, and the leftward direction propagation phase of the input light ray; and
calculating an output electric field based on a twelfth transfer matrix of the plurality of transfer matrices generated for the outcoupling grating, the eighth transfer matrix, the leftward propagating electric field of a neighboring node, and the leftward direction propagation phase of the input light ray,
wherein the output electric field generated for each node in the area of the grid corresponding to the outcoupling grating is included in the plurality of electric fields.

20. A wearable head-mounted display system comprising:
an image source to project light comprising an image;
at least one lens element; and
a waveguide designed by a process comprising:
generating a plurality of transfer matrices for each diffractive grating of the plurality of diffractive gratings and background areas of the waveguide responsive to performing a diffraction modeling process for a plurality of diffractive gratings of a waveguide based on a plurality of input light rays each having at least a different first characteristic;
determining a plurality of electric fields at outcoupling positions of an outcoupling grating of the plurality of diffractive gratings based on the plurality of transfer matrices responsive to performing a ray tracing process for multiple instances of each input light ray of the plurality of input light rays with at least a different second characteristic; and
generating a uniformity map for the waveguide based on the plurality of electric fields, the uniformity map indicating a uniformity of one or more characteristics of the waveguide across different sampled pupil positions.
